(19) United States
(12) Patent Application Publication
(10) Pub. No.: US 2011/0277193 A1
(43) Pub. Date: Nov. 10, 2011

(54) SENSORS AND BIOSENSORS

(75) Inventors: Alexander B. SMETANA, Park Ridge, IL (US); Saju R. Nettikadan, Hawthorne Woods, IL (US)

(73) Assignee: Nanolnk, Inc.

(21) Appl. No.: 13/090,827

(22) Filed: Apr. 20, 2011

Related U.S. Application Data
(60) Provisional application No. 61/326,103, filed on Apr. 20, 2010.

(51) Int. Cl. G01Q 70/18; G01Q 70/08

(52) U.S. Cl. 850/56; 850/61

(57) ABSTRACT

Multiplexed printing and sensors for biological applications. Sensors can be made with high sensitivity and by high throughput methods. Multiple capture molecules can be applied to the same or different sensor elements such as cantilevers. The sensor element can be a microcantilever. Direct write lithography from nanoscopic tips can be used to make the sensor. Proteins and hydrogels can be printed. Specific binding can be detected.

### CROSS REFERENCE TO RELATED APPLICATIONS

This application claims benefit to U.S. Provisional Patent Application No. 61/326,103, filed Apr. 20, 2010, which is incorporated herein by reference in its entirety.

### BACKGROUND

A need exists to provide better methods for multiplexed printing of small structures. In addition, a need exists to develop more sensitive, accurate, versatile, robust, and low cost sensing methods, and methods for making and using these improved sensors. In particular, biologically-related sensing is an important commercial need, and multiplexed biological structures are needed. For example, many areas of medicine will be advanced by better sensors. Also needed are high throughput methods for making and using sensors.

### SUMMARY

Embodiments provided herein include, for example, devices, articles, kits, and compositions, and methods of making and methods of using the same.

One embodiment provides, for example, multi-plexed addressable printing to prefabricated structures at the nano- and micro-scale. The printing can be used, for example, to form sensors and lab-on-a-chip devices. The prefabricated structure can be, for example, a cantilever, a microfluidic channel, a PDMS pillar array or a PDMS maze.

In one embodiment, provided is a method for functionalizing sensors comprising: providing a sensor element; providing a pen array comprising at least a first tip and a second tip; coating the first tip with a first ink composition and the second tip with a second ink composition; functionalizing the sensor element by simultaneously depositing the first ink composition and second ink composition from the tips to the sensor element to form a first pattern and a second pattern each having a lateral dimension of 10 microns or less.

In one embodiment, the first and second patterns each have a lateral dimension of 1 micron or less. In one embodiment, the first and second tips are atomic force microscope tips. In one embodiment, the pen array is a one-dimensional pen array. In one embodiment, the pen array is a two-dimensional pen array.

In one embodiment, the sensor element comprises a microcantilever. In one embodiment, the sensor element comprises a nanocantilever. In one embodiment, the sensor element comprises a vibrating stiff cantilever. In one embodiment, the sensor element comprises a flexible cantilever. In one embodiment, the sensor element comprises a microfluidic channel. In one embodiment, the sensor element comprises a PDMS pillar array. In one embodiment, the sensor element comprises a PDMS maze.

In one embodiment, the ink compositions comprise capture molecules. In one embodiment, the ink compositions comprise proteins, peptides, or nucleic acids. In one embodiment, ink compositions comprise an aqueous carrier. In one embodiment, the ink compositions comprises a surfactant or a matrix component.

In one embodiment, the deposition results in at least one line being formed. In one embodiment, the deposition results in at least one dot being formed. In one embodiment, the deposition results in a line width or a dot diameter of about one micron to about ten microns. In one embodiment, the deposition results in a line width or a dot diameter of about one micron or less. In one embodiment, the first pattern comprising a capture molecule different from the second pattern.

In one embodiment, the functionalized sensor element is substantially free of cross-contamination. In one embodiment, the functionalized sensor element is substantially free of contamination in the background. In one embodiment, the sensor element comprises an pre-fabricated surface structure comprising an arbitrary and non-flat surface, and wherein the deposition is adapted to the arbitrary and non-flat surface to be substantially free of both cross-contamination and contamination in the background.

In one embodiment, the pen array comprises at least 4 tips, or at least 8 tips. In one embodiment, the pen array comprise a plurality of cantilevers, wherein at least one of the cantilevers comprises a front surface, a first side edge, a second side edge, and a first end which is a free end, and a second end which is a non-free end, and wherein the front surface comprises (1) at least one first sidewall disposed at the first cantilever side edge and at least one second sidewall disposed at the second cantilever side edge opposing the first cantilever side edge, (2) at least one channel, adapted to hold a fluid, disposed between the first and second sidewalls, wherein the channel, the first sidewall, and the second sidewall extend toward the cantilever free end but do not reach the free end, and (3) a base region having a boundary defined by the first edge, the second edge, and the cantilever free end and also the first sidewall, second sidewall, and the channel, wherein the base region comprises a tip extending away from the cantilever front surface. In one embodiment, the channel, the first side wall and the second side wall are all tapered to become gradually narrower as they extend toward the base region, and wherein the base region is substantially flush with the bottom surface of the channel. In one embodiment, the pen array comprises at least one DPN M-exp tips.

Another embodiment provides a method for functionalizing sensors comprising: providing a sensor element; providing at least one cantilever, wherein the cantilevers comprises a front surface, a first side edge, a second side edge, and a first end which is a free end, and a second end which is a non-free end, and wherein the front surface comprises (1) at least one first sidewall disposed at the first cantilever side edge and at least one second sidewall disposed at the second cantilever side edge opposing the first cantilever side edge, (2) at least one channel, adapted to hold a fluid, disposed between the first and second sidewalls, wherein the channel, the first sidewall, and the second sidewall extend toward the cantilever free end but do not reach the free end, and (3) a base region having a boundary defined by the first edge, the second edge, and the cantilever free end and also the first sidewall, second sidewall, and the channel, wherein the base region comprises a tip extending away from the cantilever front surface; coating the tip with a ink composition comprising sensor molecules; functionalizing the sensor element by depositing the sensor molecules from the tip to the sensor element to form a pattern having a lateral dimension of 10 microns or less, wherein the sensor molecules in the pattern are adapted to detect at least one analyte from a sample.

Briefly, also provided is a device comprising: a chip; wherein the chip comprises a plurality of sensor elements; wherein each sensor element comprises a plurality of patterns disposed thereon, wherein at least one pattern has a lateral dimension of less than 10 microns, wherein at least one sensor element comprises a first pattern comprising first sensing molecules and a second pattern comprising second sensing molecules, and wherein the first sensor molecules are different from the second sensor molecules.

In one embodiment, the chip comprises at least 10 sensor elements. In one embodiment, the chip comprises at least 50 sensor elements. In one embodiment, at least one sensor element comprises at least 5 patterns. In one embodiment, at least one sensor element comprises at least 50 patterns. In one embodiment, at least one pattern has a lateral dimension of 1 micron or less. In one embodiment, the first pattern and the second pattern are separated by a distance of 1 micron or less.

In one embodiment, the sensor elements comprise microcantilever. In one embodiment, the sensor elements comprise nanocantilever. In one embodiment, the sensor elements comprise vibrating stiff cantilever. In one embodiment, the sensor elements comprise flexible cantilever. In one embodiment, the sensor elements comprise microfluidic channel. In one embodiment, the sensor elements comprise PDMS pillar array. In one embodiment, the sensor elements comprise PDMS maze. In one embodiment, at least one sensor element comprises a pre-fabricated surface structure, and wherein the pre-fabricated surface structure is arbitrary and non-flat.

In one embodiment, the sensing molecules comprise capture molecules. In one embodiment, the sensing molecules comprise protein. In one embodiment, the sensing molecules comprise nucleic acids. In one embodiment, the sensing molecule comprises antibodies or an antigens. In one embodiment, the sensing molecules are chemisorbed or covalently bonded to the sensor elements.

In one embodiment, at least part of at least one sensor element is passivated.

Briefly, also provided is a device comprising: a sensor chip; wherein the chip comprises a plurality of sensor elements, including at least a first sensor element and a second sensor element; wherein each sensor element comprises a plurality of patterns each having at a lateral dimension of less than 10 microns disposed thereon, wherein at least one pattern on each sensor element comprises a sensing molecule; and wherein the first sensor element comprises at least one sensing molecule different from the second sensor element.

In one embodiment, at least one sensor comprises a first pattern comprising a first sensing molecule and a second pattern comprising a second sensing molecule, and wherein the first sensor molecule is different from the second sensor molecule.

Another embodiment provides a method for functionalizing sensors comprising: providing a chip, wherein the chip comprises a plurality of sensor elements; providing a pen array comprising at least a first tip and a second tip; coating the first tip with a first ink composition comprising at least one first sensing molecule and the second tip with a second ink composition comprising at least one second sensing molecule, wherein the first sensing molecule is different from the second sensing molecule; functionalizing the chip by simultaneously depositing the first ink composition and second ink composition from the tips to at least one of the sensor elements to form a first pattern comprising the first sensing molecule and a second pattern comprising the second sensing molecule, wherein the first pattern and the second pattern each have a lateral dimension of 10 microns or less; and wherein the functionalized chip is capable of sensing at least one analyte from a sample.

Another embodiment provides a method for functionalizing sensors comprising: providing a chip, wherein the chip comprises a plurality of sensor elements including at least one first sensor element and one second sensor element; providing a pen array comprising a plurality of tips each coated with an ink composition comprising at least one sensing molecule; functionalizing the chip by depositing the ink compositions from the tips to the sensor elements to form a plurality of patterns on each sensor element; wherein the patterns each has a lateral dimension of 10 microns or less; wherein the functionalized chip are capable of sensing at least two different analyte from a sample; and wherein the first sensor element is capable of sensing an analyte different from the second sensing element.

At least one advantage for at least one embodiment includes improved spatial resolution in preparing sensor elements.

At least one advantage for at least one embodiment is ability to sense multiple analytes at the same time.

At least one advantage for at least one embodiment is more sensitive sensing. At least one advantage for at least one embodiment is more accurate sensing.

### BRIEF DESCRIPTION OF THE DRAWINGS

FIG. 1 illustrates (Top) Brightfield live image showing the printing of 6-micron dots of fluorescently tagged IgG onto a commercially available AFM cantilever using Nanolnk M-exp type tips. (Bottom) Fluorescent image of the printed domains on the cantilever.

FIG. 2 illustrates four different fluorescently tagged proteins printed on custom cantilever arrays having different spring constants.

FIG. 3 illustrates (Top) a stiff cantilever and Nanolnk M-exp type tips used for fabricating sensors, as well as (Bottom) flexible cantilevers according to one embodiment of the present application.

FIG. 4 illustrates a functionalized biosensor according to one embodiment of the present application, wherein the sensor is fabricated on a stiff cantilever.

FIG. 5 illustrates a functionalized biosensor according to one embodiment of the present application, wherein the sensor is fabricated on flexible cantilevers.

FIG. 6 illustrates functionalized biosensors according to one embodiment of the present application, wherein the sensors are fabricated in microfluidic channels.

FIG. 7 illustrates a functionalized biosensor according to one embodiment of the present application, wherein the sensor is fabricated in a microfluidic channel.

FIG. 8 illustrates printing on top of a commercially available microfluidic system

FIG. 9 illustrates a functionalized biosensor according to one embodiment of the present application, wherein the sensor is fabricated on a 10 micron PDMS pillar array, as well as a Nanolnk M-exp tip for functionalizing the biosensor.

FIG. 10 illustrates a functionalized biosensor according to one embodiment of the present application, wherein the sensor is fabricated on a 10 micron PDMS pillar array, as well as a non-functionalized PDMS pillar array.

FIG. 11 illustrates a functionalized biosensor according to one embodiment of the present application, wherein the sensor is fabricated on a PDMS maze.

FIG. 12 illustrates a functionalized biosensor according to one embodiment of the present application, wherein the sensor is fabricated on a PDMS maze.

FIG. 13A is a top plan view of known cantilevers 100. Cantilevers such as shown here can be obtained from Nanolnk (Skokie, Ill.). The cantilevers form part of a linear array of cantilevers, wherein deposition is designed to occur from the tip of the cantilever to a substrate.

FIG. 13B is a top plan view of known cantilevers 100 during their normal operation including ink disposed on the cantilever for deposition to a substrate.

FIG. 13C is a top plan view of known cantilevers 100 having fluid droplets formed on their surfaces and moving away from the tip where deposition from the tip to a substrate should occur.

FIG. 14A is a perspective view of a known cantilever 210 having a recessed area 214 at the end portion 212 of the cantilever, where the recessed area 214 surrounds the tip 216.

FIG. 14B is a perspective view of a cantilever 220 having a first recessed area (channel) 221 and a second recessed area 224.

FIG. 14C is a perspective view of a cantilever 230 in accordance with an embodiment. The first elongated portion of the recessed area (channel) 231 is tapered. The upper surfaces of the side walls 235a, 235b are also tapered.

FIG. 14D is a side view of a cantilever 230 shown in FIG. 2C in one embodiment.

FIG. 14E is a side view, for one embodiment, of a cantilever 240 having a side wall 245b for the channel, and a side wall 244b for the second expanded portion of the recessed area 244. The side wall 244b has a height lower than that of the side wall 245b.

FIG. 15A illustrates diagram of multiple masks (shown in different color) used to fabricate the cantilever structures.

FIG. 15B illustrates diagram of multiple masks (shown in different color) used to fabricate the cantilever structures in accordance with embodiments disclosed herein.

FIG. 15C is a schematic diagram of the mask shown in FIG. 3A. The upper surfaces 350a, 350b of the side walls each have substantially parallel edges (as indicated by the 101 degree angle), i.e., the width of each of the upper surfaces is substantially constant along the length of the channel (shown as 12 um and 11 um at the two ends.)

FIG. 15D is a schematic diagram of the mask shown in FIG. 3B. The upper surfaces 360a, 360b of the side walls of the channel 331 each have tapered shapes, with a width narrowing by about 50% toward the end portion (from 9 um to 4 um). The angle between an inner edge of the upper surface 360b (101 degree) and the end edge of the channel is smaller than that between the outer edge and the end edge of the channel.

### DETAILED DESCRIPTION

### INTRODUCTION

References cited herein are incorporated by reference in their entirety. Instruments, materials, devices, accessories, and kits can be obtained from Nanolnk, Inc. (Skokie, Ill.).

Priority U.S. Provisional Patent Application No. 61/326,103, filed Apr. 20, 2010, is incorporated herein by reference in its entirety.

### SENSORS

Micro and nano electromechanical (MEMS and NEMS) sensors are known in the art. Sensors can be physical sensors or chemical sensors. Sensors can be used, for example, to diagnose biological diseases. Sensors can be used to detect multiple analytes simultaneously.

Technical literature describing sensing and related devices and methods include, for example, (1) Sauran et al., Anal. Chem., 2004, 76, 3194-3198; (2) Dhayal et al., J. Am. Chem. Soc., 128, 11 (2006), 3716-3721; (3) Dutta et al., Anal. Chem., 2003, 75, 2342-2348; (4) Belaubre et al., Applied Physics Letters, 2003, 82, 18, 3122, (5) Yue et al., Nanoletters, 2008, 8, 2, 520-524; (6) Lynch et al., Proteomics, 2004, 4, 1695-1702.

Patent literature includes, for example, US Patent Publication numbers 2010/0086992 (Himmelhaus et al.) and 2010/0086735 (Baldwin et al.).

### DIRECT WRITE LITHOGRAPHY INCLUDING NANOLITHOGRAPHY

Direct write lithography and nanolithography are known in the art. For example, an ink composition can be disposed on the tip and the ink composition can be transferred from tip to a substrate. Dip pen methods can be used. Nanoscale and microscale printing can be carried out. The following references are incorporated herein by reference in their entireties: US patent publication 2010/0048427 (matrix ink); US patent publication 2009/0143246 (matrix ink); US patent publication 2010/0040661 (stem cells); US Patent publication 2008/0105042 (two dimensional arrays); US patent publication 2009/0325816 (two dimensional arrays); US patent publication 2008/0309688 (viewports); US patent publication 2009/0205091 (leveling); US patent publication 2009/0023607 (instrument); US patent publication 2002/0063212 (DPN); US patent publication 2002/0122873 (APN); US patent publication 2003/0068446 (protein arrays); US patent publication 2005/0009206 (protein printing); US patent publication 2007/0129321 (virus arrays); US patent publication 2008/0269073 (nucleic acid arrays); US patent publication 2009/0133169 (inking of cantilevers); US patent publication 2008/0242559 (protein arrays); U.S. provisional application No. 61/225,530 (hydrogel arrays); U.S. provisional application No. 61/314,498 (hydrogel arrays); U.S. provisional application No. 61/324,167 and PCT/US2011/032369 filed Apr. 13, 2011 (improved pens); U.S. Pat. No. 7,034,854 (inkwells); WO 2009/132321 (polymer pen lithography); WO 2010/096591; WO 2010/124210; WO 2010/141836; Jang et al., Scanning, 31, (2000), 1-6.

### PEN ARRAY

Pen arrays are known in the art. See, for example, US patent publication 2008/0105042. The pen array can be either a one-dimensional array or a two-dimensional array. In one embodiment, the pen array comprises a plurality of cantilevers each comprising a tip. The number of cantilevers in such a pen array can be, for example, at least 4, at least 8, at least 12, or at least 250.

### TIPS

Cantilevers and tips disposed at the end of cantilevers are known in the art. Tips can be used which are solid and non-hollow. They can be free of an aperture. They can be nanoscopic tips. They can be scanning probe microscope tips, including atomic force microscope tips. They can have a tip radius of less than 100 nm, for example, or less than 50 nm, or less than 25 nm, for example. Tips can be sharpened and cleaned by methods known in the art. Tips can be surface treated to improve deposition as known in the art. See, for example, US patent publication 2008/0269073 (nucleic acid arrays); US patent publication 2003/0068446 (protein arrays); and US patent publication 2002/0063212 (DPN). Plasma cleaning can be used as needed. In one embodiment, NanoInk M-exp tips are used for functionalizing the sensors.

### SENSOR CHIP

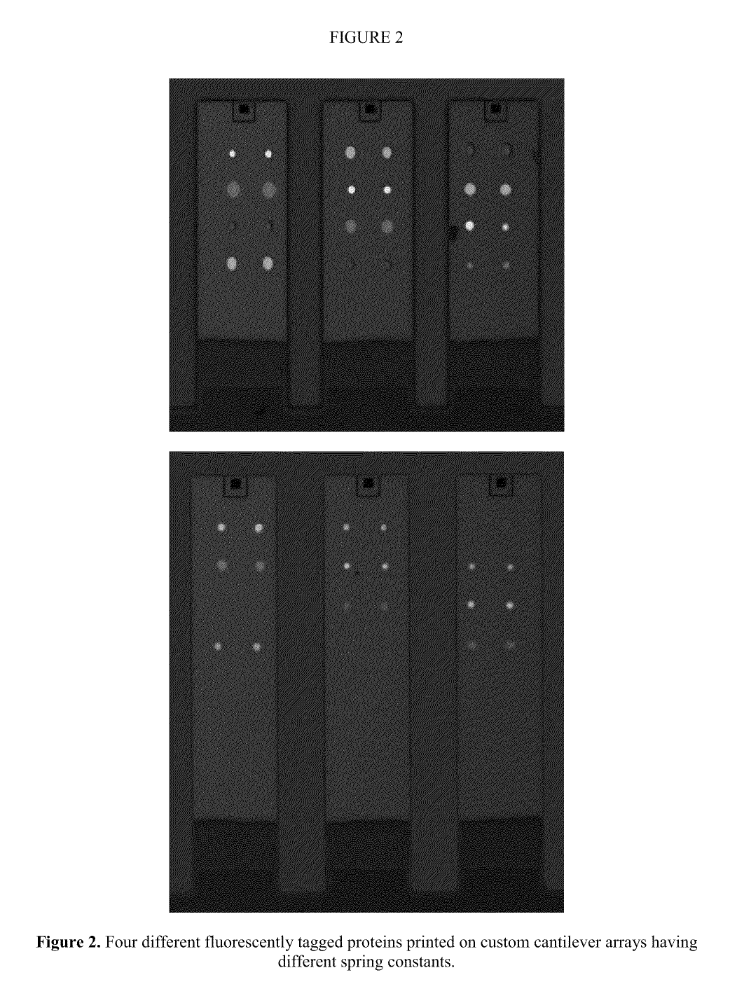

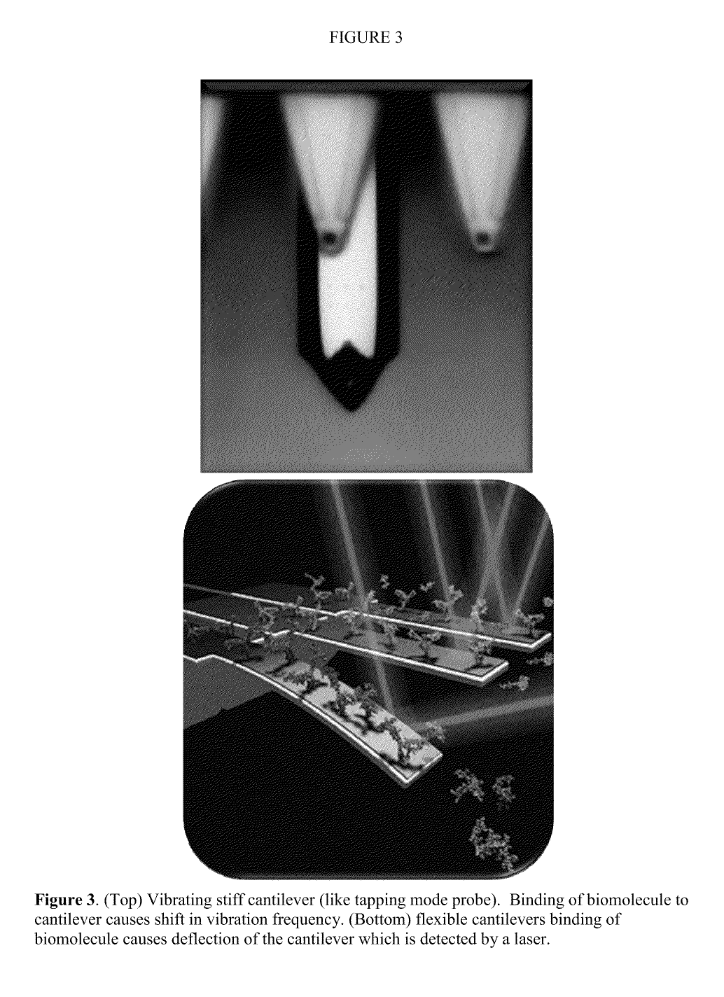

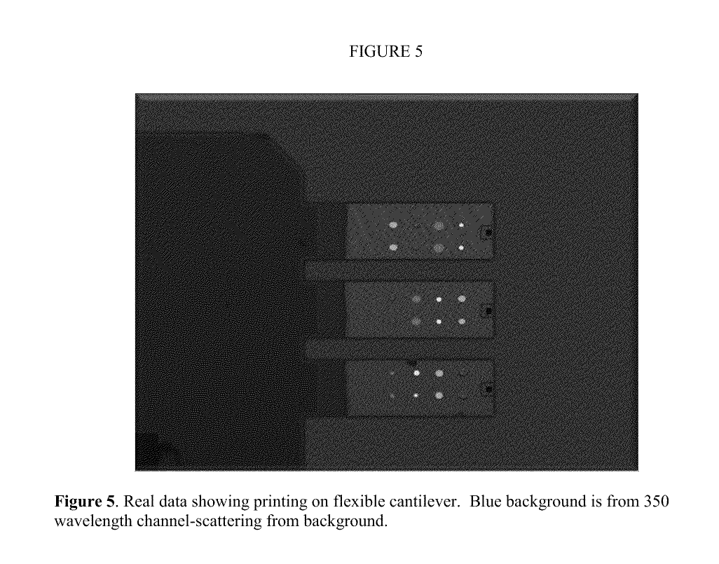

Sensor chips, including lab-on-a-chip (LOC), are known in the art. See, for example, Yue et al., Nanoletters, 2008, 8, 2, 520-524. In one embodiment of the present application, the sensor chips comprise a plurality of sensor elements, such as cantilevers. The plurality of sensor elements may be placed on the sensor chip as a array. The number of such sensor elements on a single sensor chip can be, for example, at least 3, at least 10, at least 50, or at least 100. For example, FIG. 2, FIG. 3 (Bottom), and FIG. 5 each shows a sensor chip comprising at least three sensor elements. In one embodiment, the sensor chip has at least one lateral dimension of, for example, 20 cm or less, or 10 cm or less, or 5 cm or less, or 2 cm or less. The size of the chip can be, for example, more than 1000 cm², between 100 cm² to 1000 cm² , between 10 cm² to 100 cm² , between 1 cm² to 10 cm² , or even less than 1 cm².

### SENSOR ELEMENT

Sensor elements are known in the art. See, for example, Dutta et al., Anal. Chem., 2003, 75, 2342-2348; Yue et al., Nanoletters, 2008, 8, 2, 520-524. In some embodiments, the sensor elements can be, for example, a cantilever, whether microcantilever or nanocantilever, a membrane, a microfluidic channel, a PDMS pillar array, a PDMS maze, or the like. Sensor elements can relate to optical, electrochemical, and electrical sensing. Sensor elements can be used which function as a substrate for biologically reactive binding moieties or capture agents.

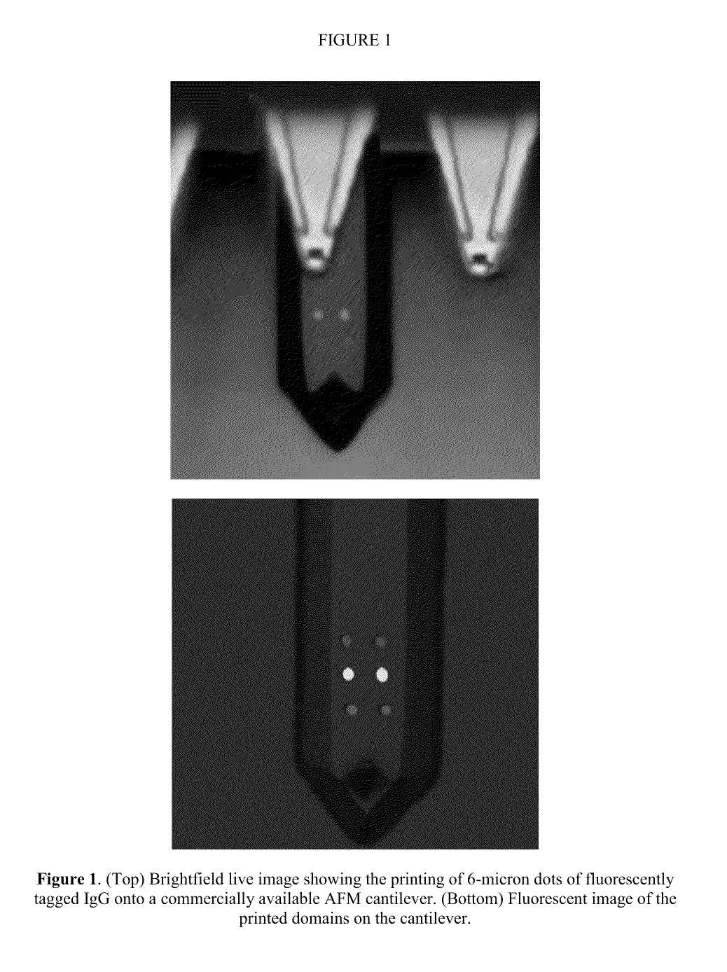

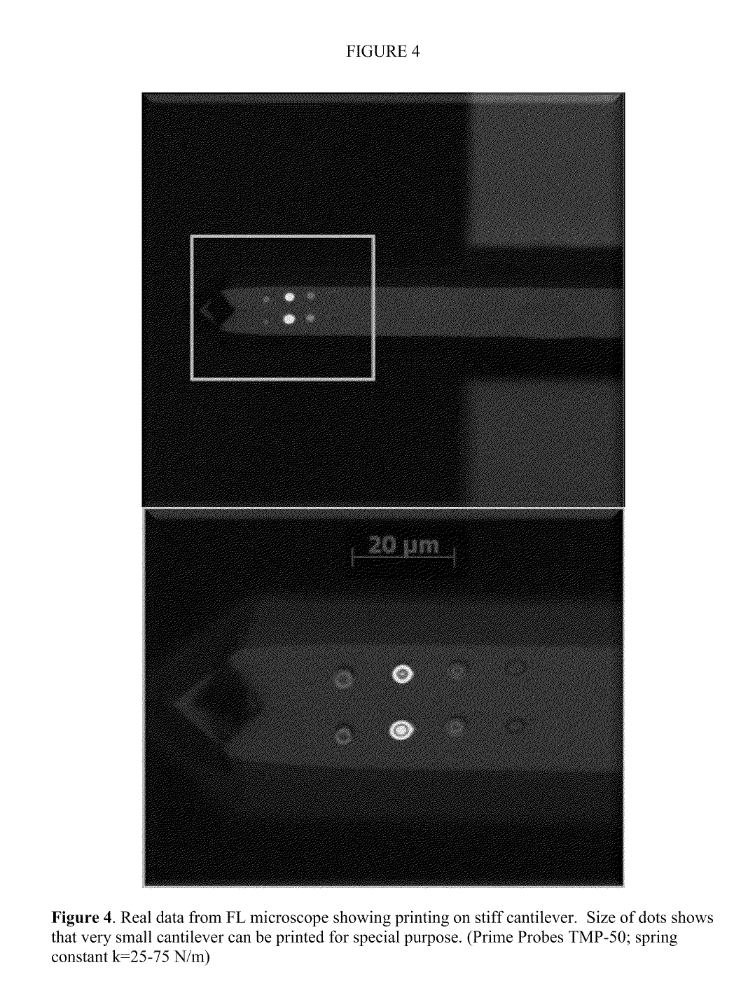

In one embodiment of the present application, a sensor element comprises a plurality of patterns disposed thereon. For example, FIG. 1 (bottom) and FIG. 4 each shows a functionalized stiff cantilever comprising 8 dot patterns. Each pattern may comprises at least one molecule capable of sensing an analyte from a sample. In a preferred embodiment, at least one sensor element is capable of simultaneously sensing multiple different analytes.

Sensor elements can be hydrophobic or hydrophilic on their surfaces. Sensor elements can be cleaned before use. For example, Sensor elements can be cleaned with plasma cleaning. The time for cleaning can be adapted to provide the best results. Sensor elements can be treated with surface coatings before use. For example, reactive silane coatings can be used. Sensor elements can be treated to have coating which block adsorption of molecules and materials such as block adsorption of proteins.

### CANTILEVER

Microcantivers and nanocantilevers are known in the art. See, for example, Goeders et al., Chem. Rev., 2008, 108, 522-542; see U.S. Pat. Nos. 7,207,206 and 7,291,466. Microcantilevers can be AFM cantilevers. Cantilevers can be A-frame type or diving board type. Cantilevers can be vibrating stiff cantilevers (shown in FIG. 4) or flexible cantilevers (shown in FIG. 5). The cantilever width, length, and shape can be increased or reduced, if desired, to improve the sensing performance and printability. Microfluidic channels can be present on the cantilever to guide fluid flow to the tip and act as a reservoir.

In one embodiment, tipless cantilevers can be used. Cantilever structures can comprise and be made of materials such as, for example, silicon nitride, silicon, and polymeric materials.

### MICROFLUIDIC CHANNELS

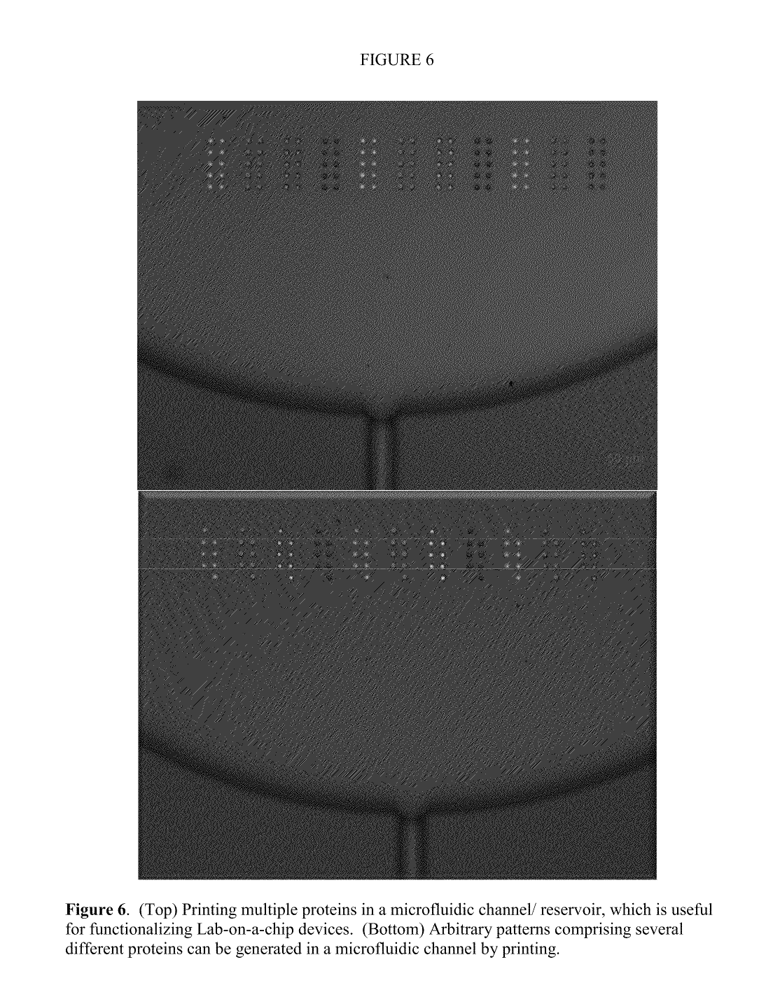

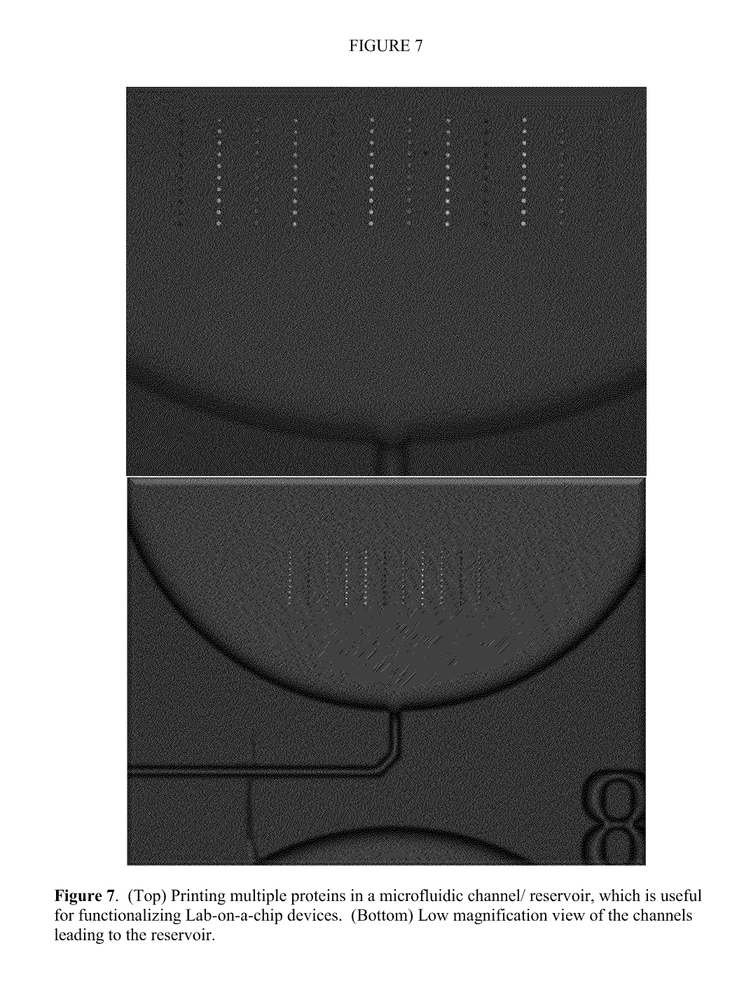

Microfluidic channels are known in the art. See, for example, US patent publication 2005/0130226 and US patent publication 2010/0304501. A microfluidic channel generally has at least one lateral dimension of less than 1 mm. Microfluidic channel based MEMS devices are very useful in biomedical research, as they require ultra-small sample volume, offer rapid reaction time and are inexpensive to operate. FIG. 6 and FIG. 7 show microfluidic channels each comprises multiple different sensing molecules disposed thereon. In one embodiment, a microfluidic channel is capable of simultaneously sensing multiple different analytes from a sample.

### PILLAR ARRAY

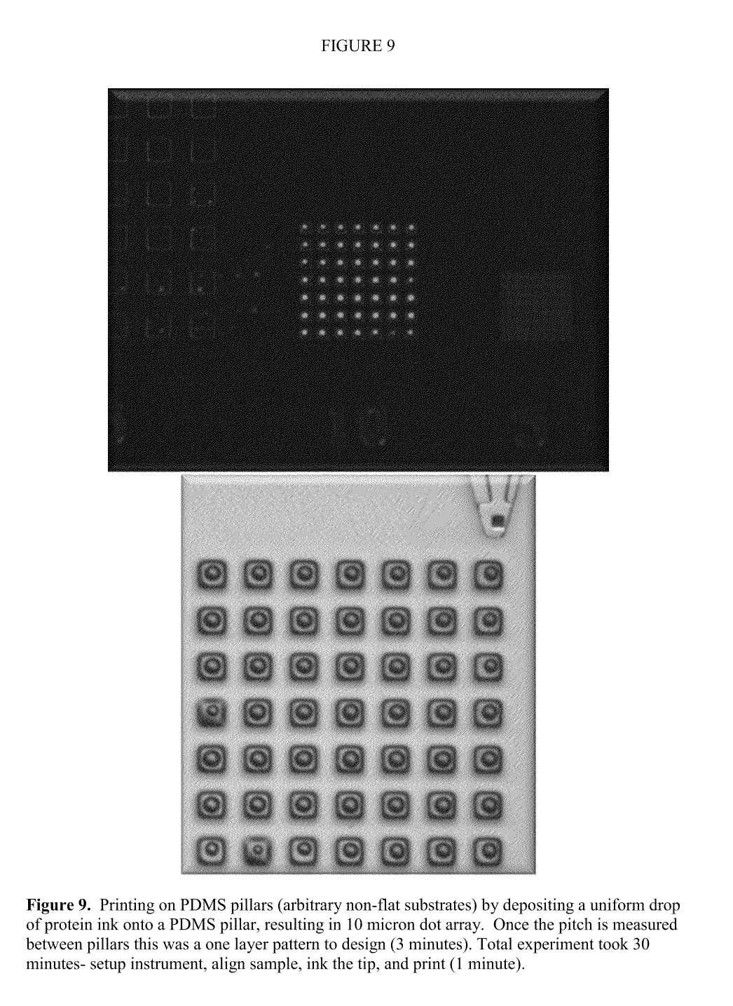

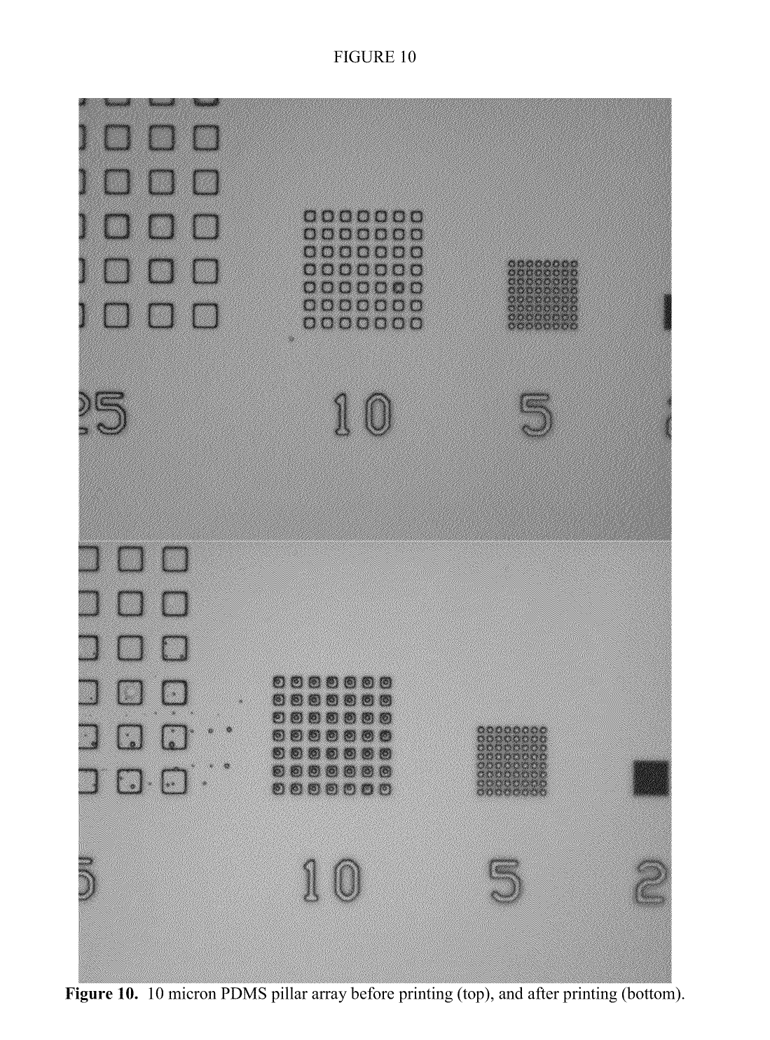

Pillar arrays including polymeric, elastomeric, and PDMS pillar arrays are known in the art. See, for example, US patent publication 2008/0169059. The fabrication of PDMS pillar array has been described in Zhao et al., Sensors and Actuators A 125:398-404 (2006). PDMS pillar arrays have been successfully used in biomedical research and lab-on-a-chip devices. See, for example, Tanaka et al., Lab on a chip 6:230-235 (2006); Zhao et al., Sensors and Actuators A, 125:398-404 (2006). A PDMS pillar array is a pre-fabricated surface structure comprising an arbitrary and non-flat surface. In one embodiment, a pillar array such as a PDMS pillars array can be functionalized with multiple sensing molecules while being substantially free of cross-contamination or contamination in the background, as shown in FIG. 9 and FIG. 10.

### MAZE

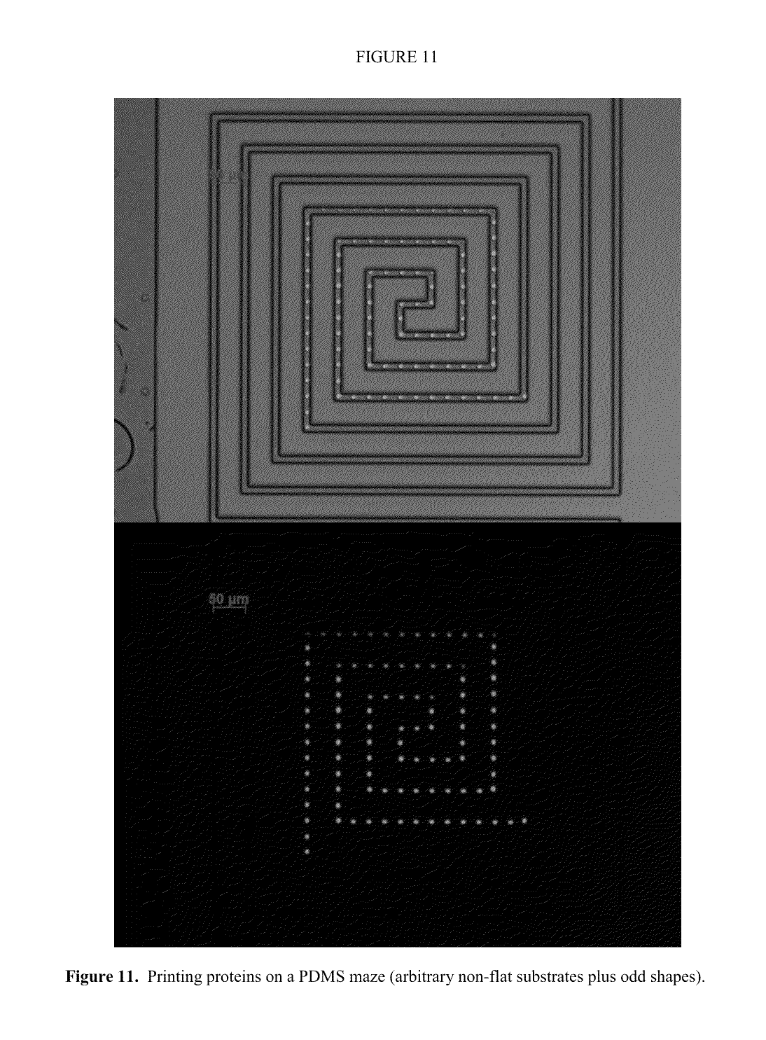

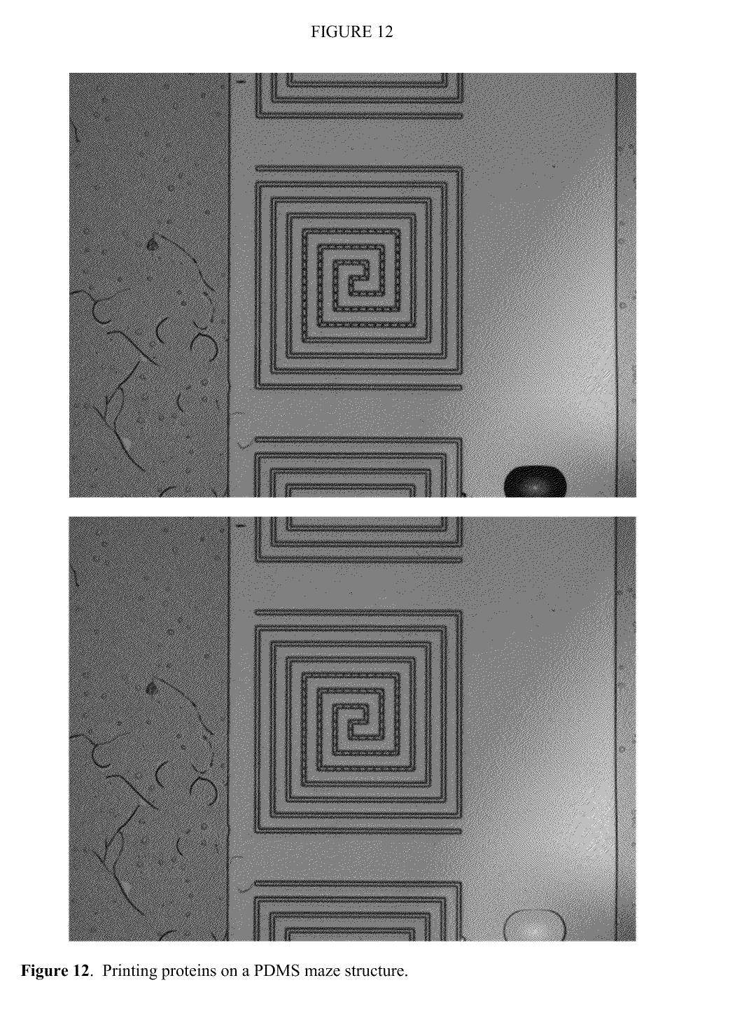

Mazes including polymeric, elastomeric, and PDMS mazes are known in the art and have been successfully used in biomedical research. See, for example, Park et al., Science 301:188 (2003). In one embodiment, a PDMS maze can be functionalized with multiple sensing molecules while being substantially free of cross-contamination or contamination in the background, as shown in FIG. 11 and FIG. 12. A PDMS maze array is a pre-fabricated surface structure comprising arbitrary and non-flat surface as well as odd shapes.

### OTHER SENSOR ELEMENTS

Other sensor elements that can be functionalized include, but are not limited to, nanowires, membranes, optical resonators, porous silicon, and diffraction gratings. In one embodiment, the functionalized sensor elements, such as nanowires, membranes, optical resonators, porous silicon, and diffraction gratings, comprise a least two different sensing molecules disposed thereon while being substantially free of cross-contamination or contamination in the background. In another embodiment, the functionalized sensor elements, such as nanowires, membranes, optical resonators, porous silicon, and diffraction gratings, are capable of simultaneously sensing multiple different analytes from a sample.

### INK COMPOSITION

Ink compositions are known in the art including those adapted for the patterning methods described herein. They can comprise at least one patterning composition or material to be patterned such as nanoparticles or other nanostructures. The ink composition can comprise at least one carrier and at least one sensing molecules to be deposited.

The carrier can be, for example, an aqueous carrier system comprising water alone or water supplemented with one or more other solvents, preferably miscible with water. The pH of the carrier can be adapted.

The sensing molecules to be deposited can be a biomolecule. Biomolecules include, for example, proteins, peptides, nucleic acids, DNA, RNA, enzymes, and the like.

The ink composition can comprise at least one synthetic polymer, including polymers designed to produce hydrogels upon further reaction (e.g., hydrogel precursors).

The ink composition can comprise additives such as, for example, surfactants.

The ink composition can comprise a matrix component for facilitating the deposition of the sensing molecules from the tip to the sensor elements. Examples of matrix component include, for example, polysaccharide and lipid. See US patent publication 2010/0048427; US patent publication 2009/0143246.

### PATTERN

In one embodiment of the present application, a sensor element is functionalized by depositing a array of patterns thereon. The patterns may be of any shape (e.g., dots, lines, circles, squares or triangles) and may be arranged in any larger pattern (e.g., rows and columns, lattices, grids, etc. of discrete sample areas). The patterns may comprise sensing molecules. One pattern may contain the same or different sensing molecules as contained in another pattern.

Each pattern may contain a single deposit of sensing molecules. For instance, the sensing molecule may be a biomolecule, such as a nucleic acid (e.g., an oligonucleotide, DNA, or RNA), protein or peptide (e.g., an antibody or an enzyme), ligand (e.g., an antigen, enzyme substrate, receptor or the ligand for a receptor), or a combination or mixture of biological materials (e.g., a mixture of proteins or nucleic acids).

The lateral dimensions of the individual patterns including dot diameters and the line widths can be, for example, about 10 microns or less, about 1,000 nm or less, about 500 nm or less, about 300 nm or less, about 200 nm or less, and more particularly about 100 nm or less. The range in dimension can be for example, about 1 nm to 10 microns, about 1 nm to about 750 nm, about 10 nm to about 500 nm, and more particularly about 100 nm to about 350 nm. A small range of about 10 nm to about 100 nm can be used.

The number of patterns on a single sensor is not particularly limited. It can be, for example, at least 5, at least 10, at least 50, at least 100, at least 1,000, even at least 10,000. Square arrangements are possible such as, for example, a 10×10 array. Higher density arrays are preferred, generally at least 100, preferably at least 1,000, more preferably, at least 10,000, and even more preferably, at least 100,000 discrete elements per square centimeter. Remarkably, the nanotechnology described herein can be used to generate ultra-high density nanoarrays comprising more than one million, more than 100,000,000, and more particularly, even more than one billion, discrete elements per square centimeter as a pattern density.

The distance between the individual patterns on the nanoarray can vary and is not particularly limited. For example, the patterns can be separated by distances of less than one micron, between one to ten microns, or more than ten microns. The distance can be, for example, about 300 to about 1,500 microns, or about 500 microns to about 1,000 microns. Distance between separated patterns can be measured from the center of the pattern such as the center of a dot or the middle of a line.

The amount of sensing molecules in a particular spot or deposit is not limited but can be, for example at a pg or ng level including, for example, about 0.1 ng to about 100 ng, and more particularly, about 1 ng to about 50 ng.

### SENSING MOLECULE

The sensing molecule deposited on the sensor element can be a capture molecule as known in the art. The capture molecule can be adapted and selected to bind with target molecules as known in the art. Specific binding can be achieved.

Examples of the capture molecule include nucleic acids, protein, peptide, antibody and antigen. Deposition of nucleic acids using DPN has been described in detail in US patent publication 2008/0269073. Deposition of protein using DPN has been described in US patent publication 2008/0242559. Multiplexed capture agent systems can be used including multiplexed nucleic acids, proteins, peptides, antibodies and antigens.

In one embodiment, the sensing molecules are modified or have chemical structures which provide for covalent bonding or chemisorption to the sensor element. The immobilized sensing molecules can retain its highly-specific recognition properties and are capable of capturing target molecules.

### TARGET MOLECULES/SAMPLES

The sample can comprise one or more target molecules as known in the art. The target molecules can be adapted and selected to bind with the capture molecules as known in the art. For example, the capture molecule can be a antibody while the target molecule can be a antigen; the capture molecule can be a receptor while the target molecule can be a ligand; and the capture molecule can be nucleic acids while the target molecule can be complementary nucleic acids.

### DEPOSITION

Deposition is well known in the art and has been described in detail in, for example, US patent publication 2002/0063212. Deposition according to present application generally includes transferring of ink composition from a tip to a substrate at microscale or nanoscale. For example, the tip can move relative to the substrate, or the substrate can move relative to the tip. Contact methods can be used wherein the tip and substrate can be contacted.

In one embodiment, ink jet printing is not carried out. Femtoliter, picoliter, and in some cases nanoliter amounts of molecules can be deposited.

The deposition can result while the tip is moving in a lateral dimension relative to the substrate, to create lines including curvilinear lines or straight lines, or while the tip is stationary in a lateral dimension relative to the substrate to create dots or circles.

Dwell time, rate of movement, and deposition rate can be adapted to provide desired line width or dot diameter.

Printing at the same spot can be repeated at the spot.

Relative humidity during printing can be adapted to improve printing. For example, relative humidity over 50%, or over 60%, can be used for printing.

### PASSIVATION

The sensor elements can be treated so they comprise both sensing molecules and a passivation agent on the surface. For example, after the sensor elements are patterned with sensing molecules, they can be passivated. In one passivation embodiment, unpatterned areas of the sensor elements can be treated with a passivation agent so as to reduce the reactivity of the unpatterned areas during further processing. Passivation can be carried out for a number of reasons including, for example, improving the selectivity of the patterned sensing molecules, or reducing the non-specific binding between the sensor elements and the target molecules. Passivation can be carried out by immersing the patterned sensor elements in solutions wherein the solution contains a passivation agent such as an alkane thiol which selectively adsorbs to the unpatterned area of the sensor elements such as gold. Hence, the passivation agent can comprise one reactive functional group which provides for chemisorption or covalent bonding to the unpatterned are, but does not have other functional groups. For example, the passivation agent can comprise a long chain alkyl group which upon adsorption exposes methyl groups to the surface which are generally unreactive to target molecules. In one embodiment, the passivation can make the rest of the sensor elements hydrophobic. For example, a gold sensor element which has already been patterned with sensing molecules can be immersed in an ethanol solution of 1-octadecanethiol (ODT, 1 mM) for 1 min. This procedure coats the unpatterned gold surface with a hydrophobic monolayer, passivating it towards the non-specific adsorption target molecules.

In another passivation embodiment, the sensor elements is first patterned with the passivation agent, followed by patterning with sensing molecules. In other words, sensor elements can be passivated before patterning. For example, substrates can be treated with a passivation agent such as, for example, an adsorption resistant hydrogel to which oligonucleotides and other nucleic acids can be bound. Passivation agents known in the art of microarray technology can be used.

### SENSING

The binding of a capture molecule to a target molecule can provide detectable changes in a sensor element such as, for example, stress, resonance, and/or deflection. The sensing molecules can also generate detectable signals, directly or indirectly, such as fluorescence and photoluminescence signals detectable by known research devices.

### APPLICATIONS

For additional use, if desired, the functionalized sensor elements can be stored in higher relative humidity to maintain hydration states for the spots, including proteins.

Applications include, for example, disease screening, point mutation analysis, blood glucose monitoring, diagnostics, tissue engineering, interrogation of sub-cellular features, use with lab-on-a-chip, basic research, and chemical and biological warfare agent detection. Other applications are described in references cited herein.

Viruses can be analyzed. Cells including stem cells can be analyzed. Antibodies and antigens can be analyzed. Attogram sensitivity can be achieved.

Additional embodiments are provided in the following non-limiting working examples.

### EXAMPLES

### MATERIALS AND METHODS

1. Instrumentation, devices, and methods were used from NanoInk, Inc. (Skokie, Ill.) including: NLP 2000 System; DPN® Pen Arrays: Type M; DPN® Pen Arrays: Type E; DPN® Inkwell Arrays: Type M-12MW; DPN® Substrates: Silicon Dioxide.

2. Inks and Inkwells:

Inks and inkwells were prepared according to procedures for printing protein inks AlexaFluor labeled inks were mixed with protein ink.

### Substrate:

Cantilevers were hydrophobic to help ensure uniform dot sizes were achieved. Cantilevers were treated in oxygen plasma cleaner for 20 seconds on medium at 200 mtorr. Evaporate Glycidoxy propyl Trimethoxy Silane (GTMO) onto the underside of the cantilevers. 2 hours at 80 deg C. and overnight without GTMO at 100° C.

3. Ink purchasing:

N-proteins and their conjugates were purchased from Invitrogen: Normal Goat catalog # 10200 5 ml 5 mg/ml; Normal mouse IgG Catalog# 10400C 5 ml; Normal Rabbit IgG Catalog # 10500C 5 ml; Donkey anti-sheep IgG (H+L) Alexa Fluor® 350 Catalog# A21097 0.5 ml *2 mg/mL*; Chicken anti-goat IgG (H+L) Alexa Fluor® 488 Catalog #A21467 0.5 ml *2 mg/mL*; Donkey anti-mouse IgG (H+L) Alexa Fluor® 546 Catalog# A10036 0.5 ml *2 mg/mL*; Chicken anti-rabbit IgG (H+L) Alexa Fluor® 647 Catalog # A21443 0.5 ml *2 mg/mL*.

4. Ink preparation:

These proteins were split into different sections. Those to be used later were vacuum sealed and placed in a −80° C. freezer. Normal-protein solutions to be used right away were diluted to 2.5 mg/ml with 1× PBS buffer. Conjugate IgG proteins were diluted 20× or 500× before reacting.

To print, the protein was combined in a 5:3 ratio with protein ink solution. This was then pipette into an M-Type inkwell using 0.3 μl to fill 3 reservoirs with each type of protein.

5. Tips:

Nanolnk M-EXP tips were used in this experiment and were oxygen plasma cleaned for 20 seconds at 200 mtorr prior to use that day.

6. Substrate:

Silicon wafers were diced and marked with a crude features with a diamond scribe. The individual Si chips were thoroughly cleaned by sonicating in ultrapure Acetone for 20 minutes followed by sonication in ultrapure Isopropanol for 20 minutes. The chips were then placed in a glass Petri dish with glycidoxy propyl trimethoxy silane (GPTMS). The GPTMS was placed by syringe into several caps from centrifuge tubes placed in the glass Petri dish. The cover was placed on the Petri dish and then was set into an oven at 100° C. for 2 hours to evaporate the GPTMS onto the substrate. The GPTMS was then removed and the substrates were reinserted into the oven at 80° C. overnight. This helped ensure the hydrophobicity of the substrate was adequate for printing a polar ink and that the proteins would be able to bind to the epoxy surface permanently.

7. Printing:

The protein inks were printed at several different humidity conditions. The most common used was 50%. At high humidity, very large dots are printed with good consistency, and at low humidity, smaller dots were printed.

The ink can be bled before printing. For larger 6 micron dots, 4 bleeding dots were usually sufficient to then print another 3-10 repeatable dots. For smaller 1-2 micron dots, 8-10 bleeding dots were needed to print 10-20 features.

To print the different proteins close to one another, advanced pattern sequences were used which would spot the first tip on the substrate and move subsequent tips to deposit features very close to the first dot. Several different printing pitches were utilized: 11 microns, 16.5 microns, and 33 microns.

To ensure that the same pressure was applied for each dot printing and that a nice round dot was formed, the writing tips were positioned 25 microns above the cantilever to be printed on. Then, the stage was moved up 20 microns and checked for printing. The stage was moved up 1 micron at a time until a single uniform dot was printed.

If a different ink has a smaller dot size (due to the different fluorophore), it was re-ink at exactly the same place to make a larger dot.

The sample were kept hydrated before imaging.

8. Reactions:

After printing, the substrate and ink were placed in a humid container (70-100% humidity) and allowed to react for 3 hours at room temperature. This allowed the protein to bind to the surface.

The substrate was then washed with milli Q water and then shaken with a mixture of PBS and 0.1% tween 20.

Then a large drop of casein protein solution was placed over the reaction area as a blocking agent and allowed to bind to the unreacted epoxy on between the printed features. This was allowed to react for 1 hour at high humidity. The substrate was again washed as above.

The three conjugate antibodies were diluted to 100μg/ml and mixed together in a single solution. This solution was placed in a large droplet over the reaction area and allowed to react for 1 hour at high humidity.

The substrate was washed a final time and observed under a fluorescent microscope.

### WORKING EXAMPLE 1

FIG. 1 and FIG. 4 illustrate a stiff cantilever functionalized according to one embodiment. Brightfield live image shows the printing of 6-micron dots of fluorescently tagged IgG onto a commercially available vibrating stiff cantilever. Size of the printed dots shows that very small cantilever can be printed for special purpose (Prime Probes TMP-50; spring constant k=25-75 N/m).

### WORKING EXAMPLE 2

FIG. 2 and FIG. 5 illustrate fluorescent images of four different fluorescently tagged proteins printed on custom cantilever arrays of flexible cantilevers having different spring constants. Blue background is from 350 wavelength channel-scattering from background.

### WORKING EXAMPLE 3

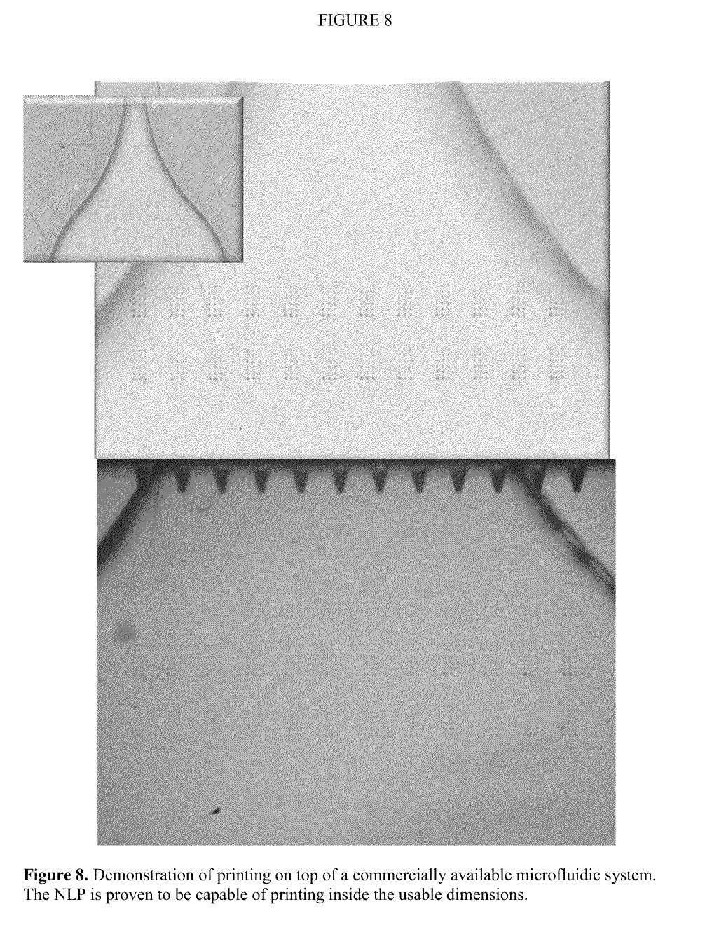

FIG. 6 and FIG. 7 illustrate functionalized microfluidic channels useful for Lab-on-a-chip devices. The dot-shaped patterns, including four different proteins, can either form a pattern array or be deposited arbitrarily inside the microfluidic channel. FIG. 8 illustrates the printing of patterns on top of a commercially available microfluidic system, which demonstrates the capability of the methods according to the present application.

### WORKING EXAMPLE 4

FIG. 9 and FIG. 10 illustrate a PDMS pillar array functionalized using DPN® M-exp tips. The PDMS pillar array, which has an arbitrary, non-flat surface, is functionalized by depositing uniform drops of protein ink onto PDMS pillars to form a 10 micron dot array. The functionalized PDMS pillar array is substantially free of cross-contamination or contamination in the background.

### WORKING EXAMPLE 5

FIG. 11 and FIG. 12 illustrate a PDMS maze functionalized according to the present application. The PDMS maze not only has an arbitrary, non-flat surface, but also has odd shapes. Nonetheless, the functionalized PDMS maze is substantially free of cross-contamination or contamination in the background.

### ADDITIONAL TIP EMBODIMENT

Some tip embodiments are particularly useful for preparation of sensors and sensor elements. See, for example, US Provisional Application 61/324,167 and PCT/US2011/032369 filed Apr. 13, 2011. For example, additional embodiments disclosed herein are directed, for example, to a device comprising at least one cantilever comprising a front surface, a first side edge, a second side edge, and a first end which is a free end and a second end which is a non-free end. The front surface can include at least one first sidewall disposed at the first cantilever side edge and at least one second sidewall disposed at the second cantilever side edge opposing the first cantilever side edge, at least one channel, adapted to hold a fluid, disposed between the first and second sidewalls, wherein the channel, the first sidewall, and the second sidewall extend toward the cantilever free end but do not reach the free end, and a base region having a boundary defined by the first edge, the second edge, and the cantilever free end and also the first sidewall, second sidewall, and the channel. The base region can comprise a tip extending away from the cantilever front surface. A fluid ink can be stored in the channel and can flow to the base region, onto the tip, and be deposited from the tip to a substrate. While not limited by theory, the fluid ink appears to move off of the side wall region, moving into the channel and/or the base region as printing progresses. In at least some embodiments, surface tension can drive fluid from the channel toward the base region. Sensor and sensor elements can be prepared.

In one embodiment, the channel is tapered and has a gradually narrowing width toward the base region. The sidewalls can be also tapered, becoming more narrow as one moves to the free end and the base region. While not limited by theory, the base region can be configured to draw the fluid from the channel by, for example, a surface tension difference between the fluid over the base and the fluid in the channel. The base region can be substantially flush with the bottom surface of the channel.

In some embodiments, the first side edge and the second side edge are not parallel, and the cantilever narrows with approach to the free end.

Another embodiment comprises a method comprising: loading at least one ink onto a device comprising a plurality of cantilevers, as described herein, comprising at least one tip on each cantilever, depositing the ink from the plurality of cantilevers and tips to a substrate, wherein at least 80%, or at least 90%, or at least 95% of the tips show successful deposition of the ink onto the substrate. The method can be used to attempt to pattern over 1,000 features, and over 80%, or over 90%, or over 95% of the features can be successfully patterned. The substrate can be a sensor or a sensor element as described herein.

In another aspect, a system can be configured to deliver fluid to form microscopic or nanoscopic pattern, the system including at least one array of microbeams, and a control device configured to control a motion of the array of microbeams. Each microbeam can include an end portion, a tip protruding from a base region of the end portion, a channel along the micro beam and in fluidic connection with the base region, wherein the channel has a side wall, and wherein the base region is recessed from an outer surface of the side wall and extends to at least one side of the end portion.

In one embodiment, the base extends to three sides of the end portion. The base can be formed by masking the end portion completely.

In one embodiment, the channel is tapered and has a gradually narrowing width toward the base region. The base is configured to draw the fluid from the channel by a surface tension difference between the fluid over the base and the fluid in the channel. The base region can have an enlarged portion of the channel, and the enlarged portion has at least one side without a side wall.

The base region can have a lateral surface substantially flush with the bottom surface of the channel. The tip can be integrally formed with the base region.

In another aspect, a method of printing a microscopic or nanoscopic pattern on a surface is provided. The method includes depositing a fluid from a channel in a cantilever to the surface at an end portion of the cantilever. The end portion includes a base region having a tip thereon, and wherein the base region has no boundary at least at one side or has a side wall substantially lower than a side wall of the channel.

The depositing can include drawing the fluid from the channel toward the base region through a surface tension difference between the fluid in the base region and the fluid in the channel. The method can further include moving the cantilever end portion relative to the surface so that the fluid is delivered from the cantilever end portion to the surface.

The fluid can form a feature on the surface with a width of about 15 nm to about 100 microns, or about one micron to about 100 microns, such as a width of about one micron to about 15 microns. In the depositing, the cantilever can be made to contact the surface.

In another aspect, a method of manufacturing a micro cantilever is provided. The method includes providing an elongated beam having an end portion, forming a tip at the end portion, apply a mask having a tapered channel region along the beam, wherein the mask portion for the channel has an expanded portion that substantially encloses the end portion, and etching the elongated beam to form the tapered region and to a base region corresponding the expanded portion, wherein the base region extends completely through at least one side of the end portion.

In another aspect, a device is provided including a cantilever, the cantilever includes a channel, two side wall areas sandwiching the channel, a tip disposed at a free end portion of the cantilever, and a broadened channel area surrounding the tip. The broadened channel area extends completely through at least one side of the free end portion.

One embodiment provides a method comprising: providing a device according to an embodiment described herein, disposing an ink in the channel and on the tip of the device, and depositing the ink from the tip to a substrate.

Another embodiment provides an instrument adapted for printing an ink onto a substrate and comprising a device as described herein.

Another embodiment provides a kit comprising a device as described herein. Another embodiment provides that the kit further comprises instructions for use of the device as described herein. Another embodiment provides that the kit further comprises an ink for use with the device as described herein.

Another embodiment provides a method comprising: loading at least one ink onto a device comprising a plurality of cantilevers comprising at least one tip on each cantilever, depositing the ink from the plurality of cantilevers and tips to a substrate, wherein at least 80% of the tips show successful deposition of the ink onto the substrate. In another embodiment, at least 90% of the tips show successful deposition of the ink onto the substrate. In another embodiment, the method is used to pattern over 1,000 features, and over 80% of the features are successfully patterned. In another embodiment, he method the method is used to pattern over 1,000 features, and over 90% of the features are successfully patterned. In another embodiment, the method is used to pattern over 1,000 features, and over 95% of the features are successfully patterned.

In another embodiment, a device is provided comprising: an elongated cantilever having a first surface and a second surface, wherein the cantilever comprises: at least one tip disposed at an end portion of the cantilever; a recessed area on the first surface, wherein the recessed area comprises: a first elongated portion along the length direction of the cantilever; and a second expanded portion around the tip.

One important embodiment is use of the methods and devices described herein to make sensors and sensor elements.

At least one advantage for at least one embodiment comprises improved deposition, including, for example, improved deposition consistency, uniformity, and/or speed. Another advantage for at least one embodiment include fewer ink replenishments needed during the printing.

a. Introduction

U.S. Provisional Patent Application No. 61/324,167, filed Apr. 14, 2010, is incorporated herein by reference in its entirety.

References cited herein may aid the understanding and/or practicing the embodiments disclosed herein. Examples of prior art references relating to printing, fabrication methods, and/or fluid flow include U.S. Pat. Nos. 6,642,129; 6,635,311, 6,827,979, 7,034,854, and 2005/0235869 which describe fundamental dip pen printing methods and associated technology of fabrication methods and fluid fow. See also, for example, US patent publications, 2008/0105042; 2009/0023607; 2009/0133169; 2010/0071098. Other examples include U.S. Pat. No. 7,610,943 and US patent publications 2003/0166263; 2007/0178014; and 2009/0104709. Other examples include U.S. Pat. Nos. 7,690,325 and 7,008,769. See also, U.S. Pat. Nos. 7,081,624; 7,217,396; and 7,351,303. See also, US Patent Publication Nos. 2003/0148539 and 2002/0094304.

Other examples include U.S. Pat. Nos. 5,221,415 and 5,399,232 to Albrecht et al. and the article entitled “Microfabrication of Cantilever Styli for the AFM”, J. Vac. Sci. Technol. A8 (4) Jul/Aug 1990 which disclose a process for making passive AFM cantilevers.

Microfabrication is generally described in M. J. Madou, Fundamentals of Microfabriation, The Science of Miniaturization.

See also, commercial printing pen and pen array products, as well as printing instruments, and other related accessories, commercially available from Nanolnk, Inc. (Skokie, Ill.).

Embodiments disclosed herein can relate to more consistent and controllable deposition of fluidic “inks” on solid surface in the femto- and attolitter volume range. In some embodiments, a new design for an Atomic Force Microscope (AFM) cantilever with microfluidic channels can improve consistent delivery of controlled amounts of chemical and biological fluids on the nanoscale. In contrast to conventional cantilever design, a cantilever in accordance with an embodiment can be fabricated with a recessed channel to retain and direct fluids toward a sharp tip at the distal end of the cantilever. The recessed area and/or the area between the recess and the edge of the cantilever can be tapered toward the tip. The tapers can result in liquids on these surfaces being driven toward the tip by surface tension. In such a design, fluids can be self-driven to the tip and can form a consistent ink flow from the tip to solid substrate. The side walls forming the channel can be also tapered, becoming more narrow as approaching the tip.

b. Microbeams and Cantilevers

Cantilevers and microbeams are known in the art including use for printing inks and imaging and manipulating surfaces. For example, “diving board” cantilevers and “A-frame” cantilevers are known. The elongated sides of the cantilever can be parallel or tapered. The cantilever can comprise a gap portion disposed at the bound end of the cantilever. The cantilevers can optionally comprise a tip at the free end. Cantilevers can be adapted for active or passive printing. Actuation methods include thermal and electrostatic. Cantilevers can form parts of arrays of cantilevers including one dimensional and two dimensional arrays.

Typical microscopic or nanoscopic printing apparatuses or systems deposit fluid using one or more elongated members reminiscent of a conventional dip pen. The elongated members can be in the form of microbeams, such as cantilevers. Cantilevers usually have an end fixed to a substrate, and another end that is free. The cantilevers can be fabricated using known technologies, such as MEMS microfabrication technologies. See, for example, references cited in the Introduction. The cantilevers, and the tips, can comprise inorganic materials such as, for example, silicon nitride, silicon dioxide, or any other suitable semiconductor material or material used in the semiconductor industry. Cantilevers, and the tips, can also comprise softer organic materials like polymers and elastomers such as silicone polymers.

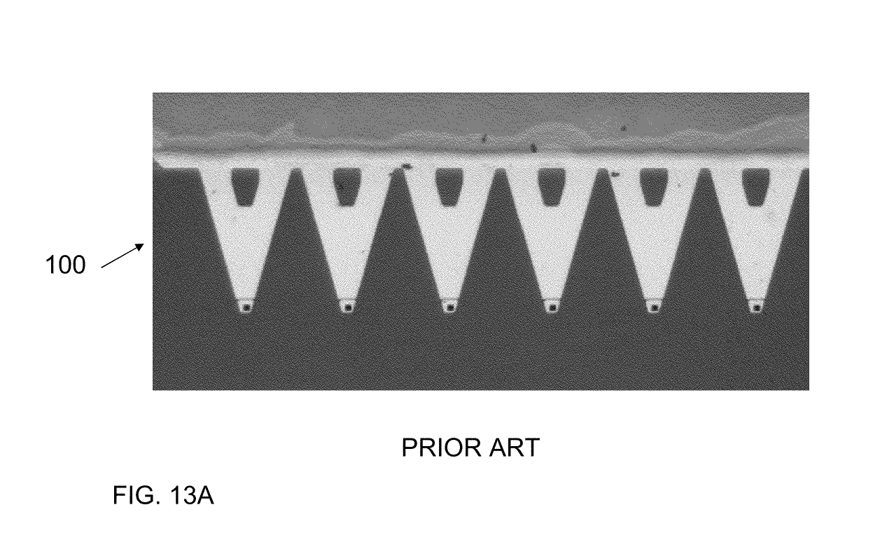

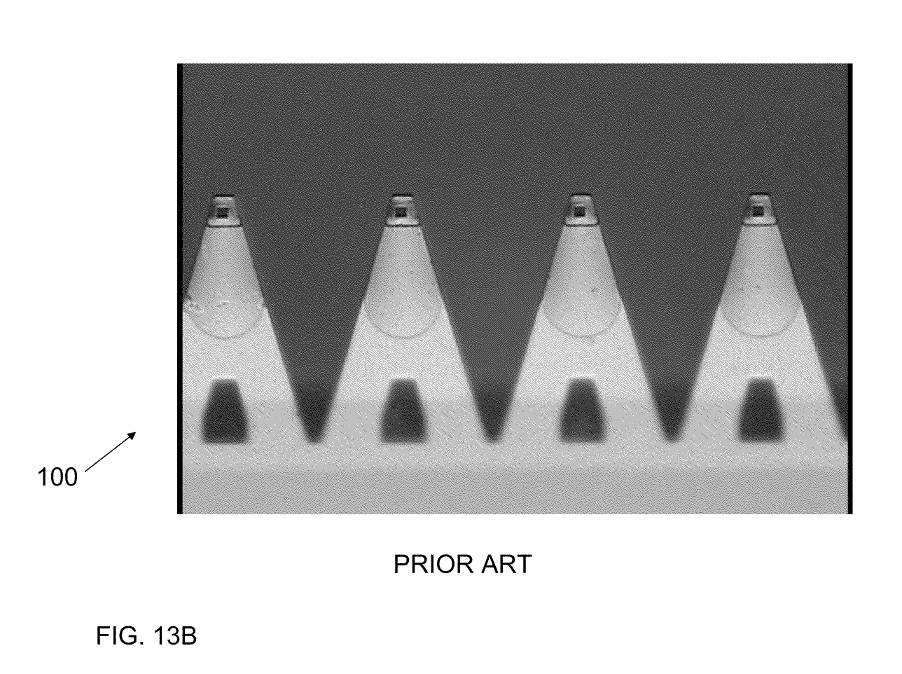

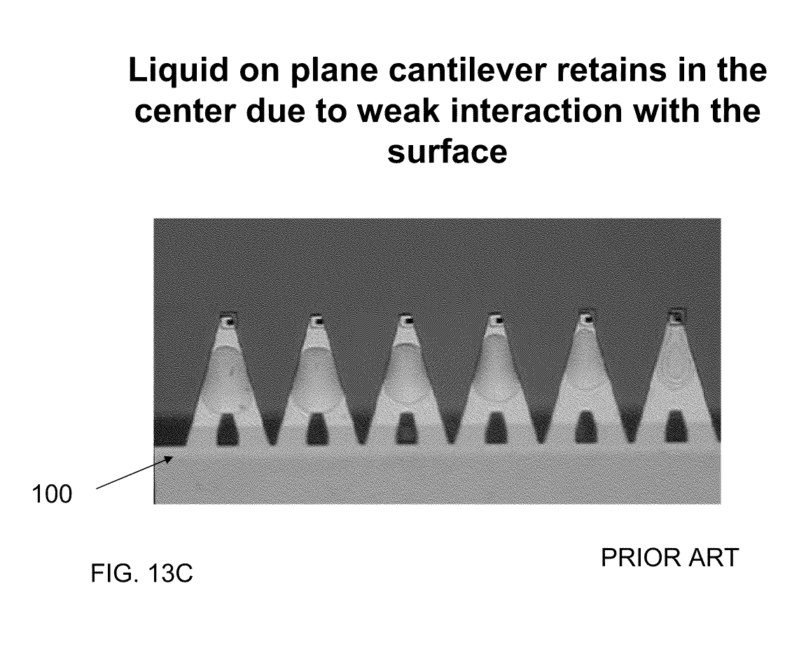

In DPN applications, as described herein, a cantilever surface works as a pool that stores and delivers inks to the probe. The process of inking can involve dipping cantilever into a micro fluidic channel or reservoirs with inks (e.g., inkwells). Typically inks spread over the cantilever surface in a form of a thin liquid film. FIG. 13 shows a top plan view of an array of conventional cantilevers 100 having fluid droplets formed on their surfaces. FIG. 13A shows the cantilever array without the ink. FIGS. 13B and 13C show the cantilevers having ink disposed on them. The inks can form droplets (which are thermodynamically more stable than a thin film of liquid) in the center of the cantilever with no connectivity to the probe. See, in particular, FIG. 13C. Unsatisfactory printing patterns can result, in some cases, from these cantilevers. In some embodiments, the fluid activity on the cantilever can lead to inconsistent printing.

The cantilever or microbeam can comprise a front surface, a back surface, a first side edge, a second side edge, a first end, and a second end. The front surface can comprise the tip, for example. The back surface can be free of a tip, for example. The first and second side edges can be elongated. The first end can be the free end. The second end can be associated with the base or be the non-free end. A base region can be associated with the first end, or the free end. The base region can comprise the tip.

If desired, more than one tip can be disposed on each cantilever.

In one embodiment, the cantilever front surface is hydrophilic. Water droplet can form a contact angle of, for example, less than 50 degrees, or less than 40 degrees, or less than 30 degrees. After the cantilever is fabricated, the cantilever can be used directly without further treatment to adjust surface hydrophilicity. Hence, in one embodiment, the cantilever front surface is not treated to change the hydrophilicity or hydrophobicity. Alternatively, the cantilever could be treated, either the whole cantilever front surface or selected parts of the front surface.

If desired, the tips can be surface modified to improve printing. For example, the surface of the tip can be made more hydrophilic. Tips can be sharpened.

In one embodiment, surface of the cantilever is treated with compounds which can passivate a surface to adsorption, such as hydrophilic compounds such as, for example, compounds comprising alkyleneoxy or ethyleneoxy units (e.g. PEG), which forms a biocompatible and hydrophilic surface layer. One advantage of this surface treatment is, for example, the inhibition of protein absorption, and thus the reduction of the activation energy required for protein transport from tip to surface. In the absence of this surface treatment, an ink comprising protein may not in some cases wet the untreated cantilever.

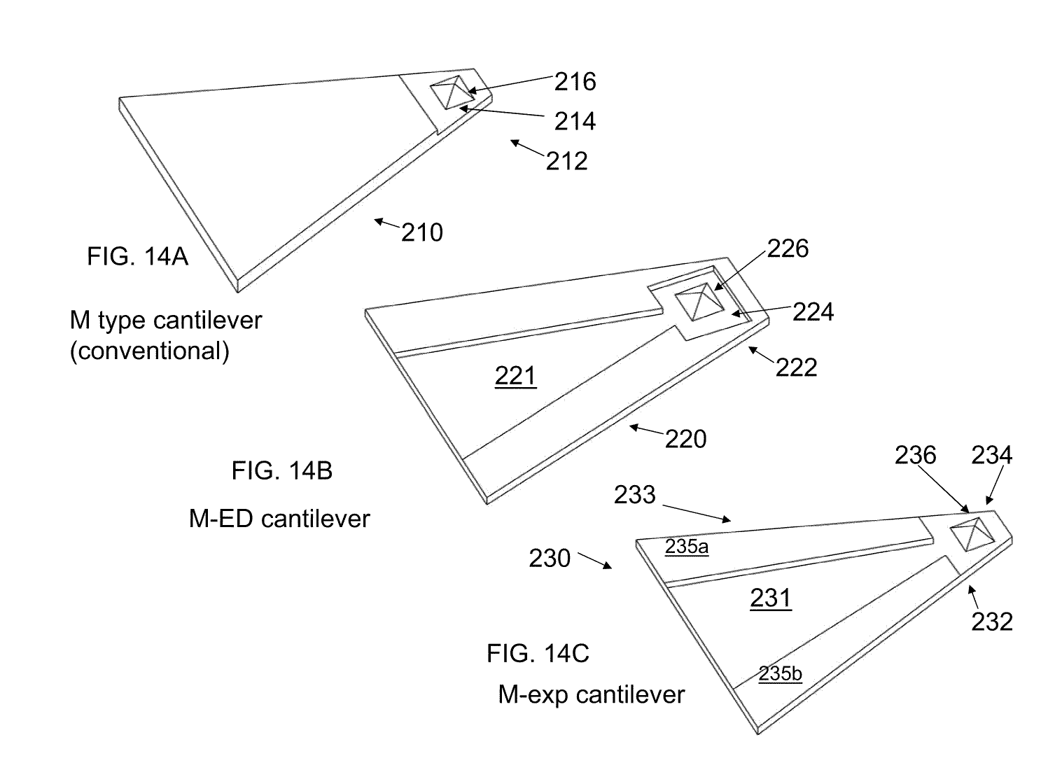

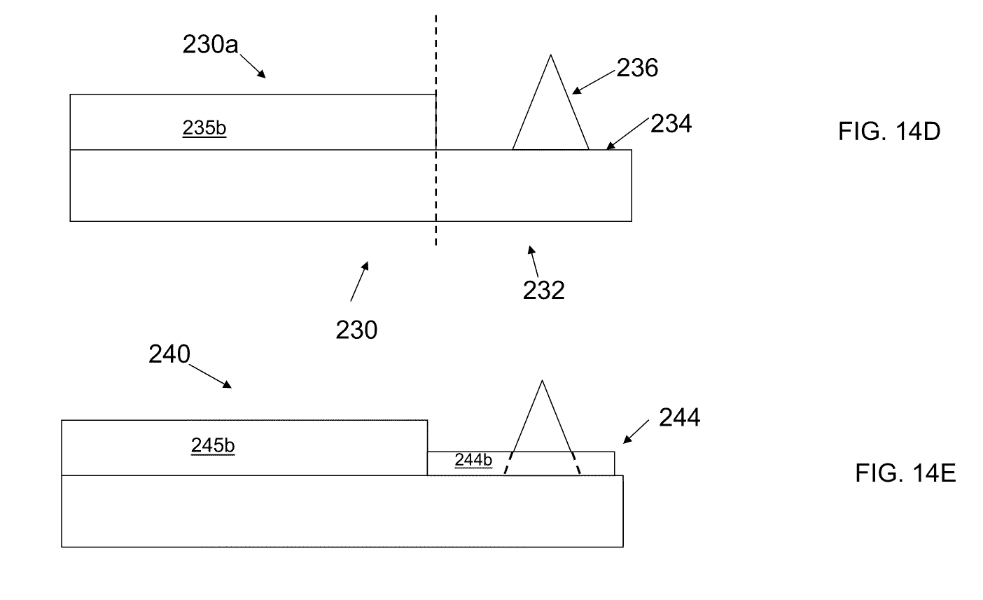

FIG. 14A is a perspective view of a conventional cantilever or microbeam 210, which includes an end portion 212 having a base region 214 in the form of a well. A tip 216 is disposed in the base region. The end portion 212 can be a free end of the cantilever. The opposing end to the left of FIG. 14A can be the fixed end of the cantilever.

c. Channels and Base Regions

Channels are generally known in the microfluidics and MEMS arts. Channels can function both to store fluid and also transport fluid. Channels can be formed from side walls, including opposing sidewalls, and a floor and also can be enclosed if desired. One end of the channel can further comprise a wall. One end of a channel can also open into a larger area and not be walled in. For example, a channel may open up into a base region as described herein so that ink can be in fluid communication with and flow from the channel into the base region.

In one embodiment, as illustrated in FIG. 14B, the cantilever 220 has a tapered recessed slot, referred to as a channel 221, which can extend from the middle of the cantilever, or from a second, fixed end portion towards a first, free end portion 222. Due to the microcavity effect of the channel 221 and its tapered profile, the inks can be held in the recessed area and can be forced to the tapered end by the surface tension. Thus, inks can be self-driven toward the end portion 222 and into the base region 224 to be deposited from the tip 226. Thus, a more consistent ink deposition from the probe to substrate surface can be achieved. In addition, the channel 221 allows storing a larger amount of inks Thus, larger areas can be deposited before the ink needs to be replenished.

### FIG. 14C

In the embodiment shown in FIG. 14C, the cantilever 230 comprises a tapered channel 231 recessed from a cantilever front surface 233. The channel 231 is tapered and has a gradually narrowing width toward the base region.

In FIG. 14C, the front surface 233 can have four edges, and can include two side wall regions 235a and 235b. The base region 234 is disposed at the end portion 232. The base region 234 has a tip 236 extending away from the front surface of the base region. In this embodiment, the side wall regions 235a, 235b do not extend into the base regions 234. Thus, unlike the structures shown in FIGS. 14A and 14B, the tip 236 is not surrounded by a side wall, and the base region 234 extends throughout the end portion 232 such that the bottom surface of the base region 234 is substantially flush with the bottom surface of the channel 231.

In the embodiment shown in FIG. 14C, the base region 234 is configured to draw the fluid (ink) from the channel 231 by a surface tension difference between the fluid over the base region 234 and the fluid in the channel 231. In particular, as the base region has essentially no boundaries, a larger fluid droplet can be formed in the base region 234 around the tip 236. The larger droplet tends to draw fluid from the channel 231 having a smaller surface area through the surface tension difference.

One embodiment, FIG. 14D, is a side view of the cantilever 230 shown in FIG. 14C. The cantilever 230 can be divided into a reservoir portion 230a and the end portion 232. The tip 236 protrudes from a bottom surface of the base region 234, which does not have a side wall as does the channel region. The base region 234 can be defined by the side walls of the channel, the channel, and the three edges of the end portion 232, but is substantially without boundaries at the three edges.

In an embodiment shown in FIG. 14E, the cantilever 240 has a base region 244 with a side wall 244b, which has a height smaller than that of the side wall 245b of the channel. The base region can extend completely through the other two edges without side walls thereon. Alternatively, the base region 244 can optionally have side walls at all three edges of the end portion.

Without boundaries or side walls, or with side walls lower than those of the channel, the base region can have less constraint on the fluid droplet held therein. Thus, the base regions 234, 244 can have larger droplets of fluid formed thereon. The larger droplets can have smaller surface tension compared with the fluid in the channel, and the fluid can be drawn from the channel into the base region by the surface tension difference. Thus, the droplet at the base region surrounding the tip can effectively provide a suction force to the fluid in the channel.

The embodiments of the cantilever designs shown in FIGS. 14B and 14C can accomplish short and long scale printing (extended printing wherein larger numbers of features can be printed).

d. Dimensions and Other Parameters for Cantilevers

One skilled in the art can vary the dimensions depending on the application. Dimensions can be adapted, for example, depending on if the cantilever is an A-frame type or a diving board type. Also, the type of ink can be considered in designing the cantilever. For example, viscosity of the ink can be considered. For example, DNA inks can be very viscous. One can use an A-Frame type cantilever with higher stiffness and spring constant.

In one embodiment, for example, the area of the cantilever front surface can be less than about 10,000 square microns. In another embodiment, the area of the cantilever front surface can be less than about 2,700 square microns.

In one embodiment, the sidewalls (both first and second) can have a height which is at least about 200 nm. In another embodiment, the sidewalls (both first and second) can have a height which is at least about 400 nm. The height of the first and second sidewalls can be the same.

In one embodiment, the first and second sidewalls can have a maximum width and a minimum width, and the maximum width can be larger than the minimum width, so that the side walls are tapered. For example, the side wall can have a maximum width of about three microns to about 20 microns, or about five microns to about 15 microns. The side wall can have a minimum width of about one micron to about ten microns, or about two microns to about eight microns. The difference in maximum and minimum sidewall width can be, for example, about three microns to about then microns.

In one embodiment, the channel can have a length of about 10 microns to about 200 microns, or about 50 microns to about 175 microns, or about 75 microns to about 160 microns. In one embodiment, the length can be about 90 microns to about 130 microns.

In one embodiment, the channel can have a maximum width of about 50 microns or less, or about 35 microns or less, or about 25 microns or less. The range can be, for example about ten microns to about 50 microns, or about 20 microns to about 30 microns. This maximum width can be at the back end of the cantilever. The width can narrow as one moves down the channel toward the free end and the base region.

In one embodiment, the channel can have a minimum width of about three to 25 microns, or about five to ten microns, or about six microns. This zone of minimum width can provide a boundary for the base region.

In one embodiment, the difference between the maximum and minimum channel width can be, for example, about five microns to about fifty microns, or about ten microns to about thirty microns, or about 15 microns to about 25 microns.

In one embodiment, the channel has its minimum width at the boundary between the channel and the base region, namely the “throat” (or a first channel end), while having its maximum width at the opposite end close to the non-free end of the cantilever, namely the “tail” (or a second channel end). The width of the tail (or second channel end) can be, for example, about 5 to 100 microns, or about 15 to 75 microns, or about 25 to 50 microns. The width of the throat (or first channel end) can be, for example, about 1 to 25 microns, or about 2 to 15 microns, or about 3 to 9 microns. The distance between the throat and the tip can be, for example, about 1 and 25 microns, or about 2 to 11 microns.

The outer edge of the sidewall can be also characterized by a first angle, and the inner edge of the sidewall can be characterized by a second angle with respect to the perpendicular cross plane of the cantilever, wherein the first angle is larger than the second angle. For example, the first angle can be about one to 20 degrees larger, or about 3 to about 10 degrees larger than the second angle. This can provide a tapering effect.

The width of the cantilever can be, for example, about 10 microns to about 100 microns, or about 20 microns to about 75 microns, or about 10 microns to about 30 microns, or about 15 microns to about 25 microns.

The tip height and tip radius can be values known in the art, including the arts of AFM imaging and use of AFM and similar tips to transfer ink from tip to surface. For example, tip height can be about 20 microns or less, or about 10 microns or less, or about five microns or less. The tip radius can be, for example, about 50 nm or less, or about 25 nm or less. Tip radius can be, for example, about 15 nm. Nanoscopic tips can be made and used.

For an array of multiple cantilevers, the pitch between the cantilever tips can be also adjusted as known in the art. Pitch can be, for example, about 50 microns to about 150 microns, or about 60 microns to about 110 microns.

In one embodiment, the first side wall, the second sidewall, and the channel are all tapered to become more narrow when moving toward the free end, and the first and second sidewalls narrow by at least four microns, and the channel narrows by at least 15 microns.

In one embodiment, the cantilever comprise silicon nitride. The thickness of such cantilever can be, for example, about 1,000 nm or less, or about 800 nm or less, or about 600 nm or less, or about 400 nm or less.

The spring constant of the cantilever can be also adapted. Examples include about 0.1 N/m to about 10 N/m, or about 0.3 N/m to about 0.7 N/m. In one embodiment, the spring constant is 0.6 N/m.

e. Inks

The inks can be adapted for loading, flow, deposition, and use with the cantilevers and microbeams described herein. For example, ink viscosity can be adapted. The concentration of solids and liquids can be adapted. Surface tension can be adapted. Surfactants can be used if needed. Additives and drying agents can be used. Aqueous and non-aqueous inks can be used and solvent proportions can be adapted for mixed solvent systems.

Inks comprising one or more biological moieties are particularly of interest. For example, proteins, nucleic acids, lipids, and the like can be used.

Inks can be also adapted for introduction of the ink onto the cantilever and use with inkwells to guide the ink to desired locations for loading.

f. Methods of Fabrication

Microfabrication methods are described in various references cited in the Introduction.

In a preferred embodiment, a sharpening mask, which has the integrated triangular fluidic channel portion for forming the channel and the connected square portion for forming the base region, can be used for sharpening the tip. The cantilever mask, which patterns the nitride, is not the original mask (M-ED) but the narrower M-type mask. This mask has narrow side areas which function to funnel the ink on those sections towards the tip. This two mask combination results in the improved ink utilization as well as the more uniform ink patterns.

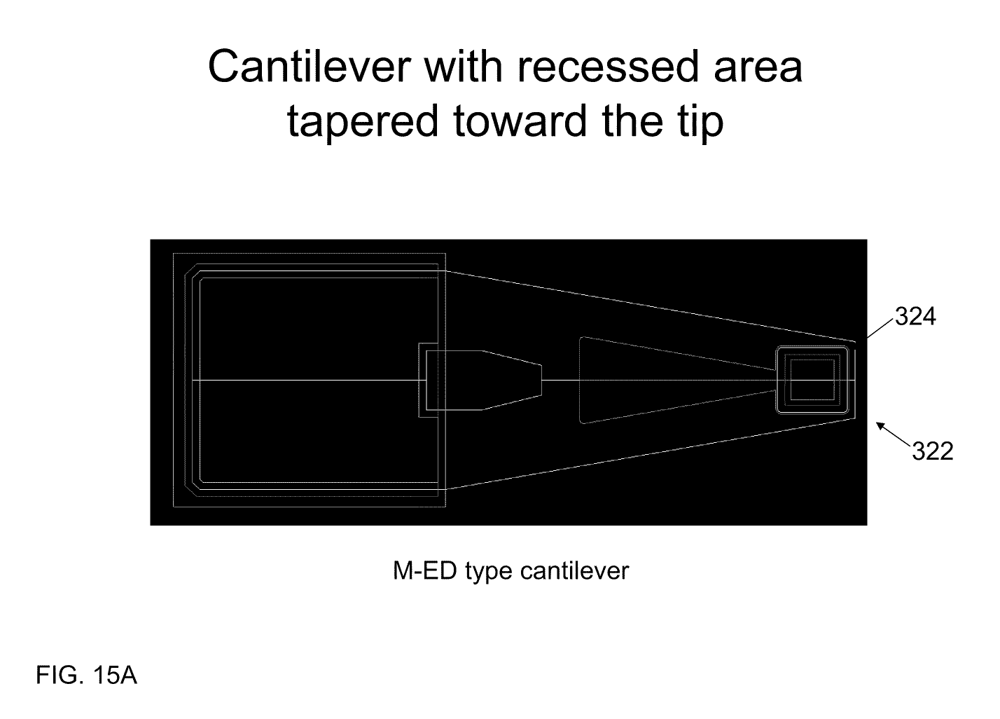

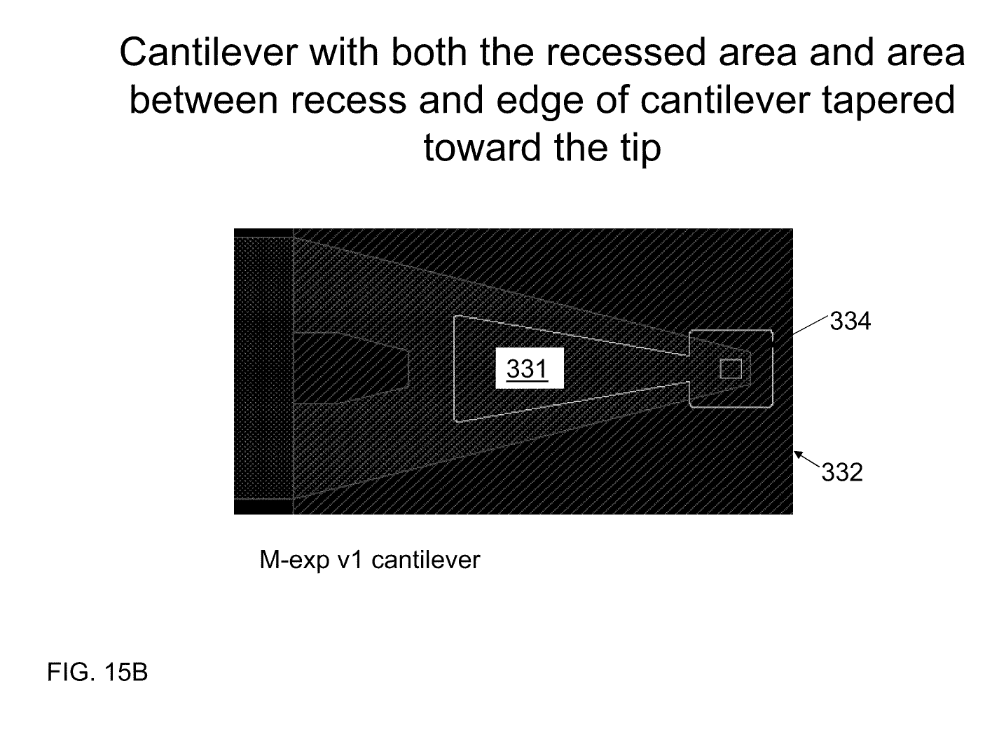

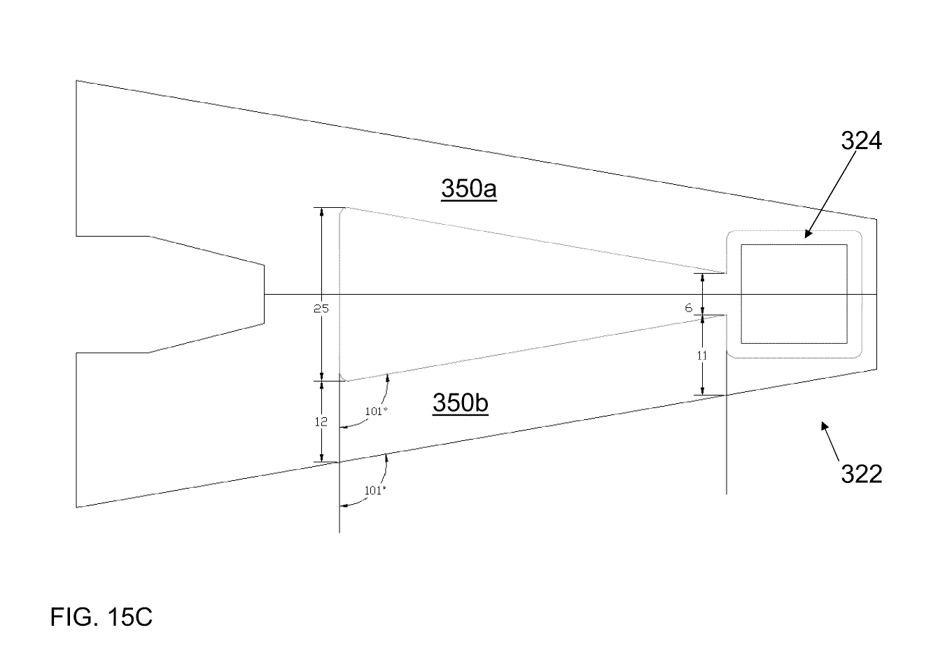

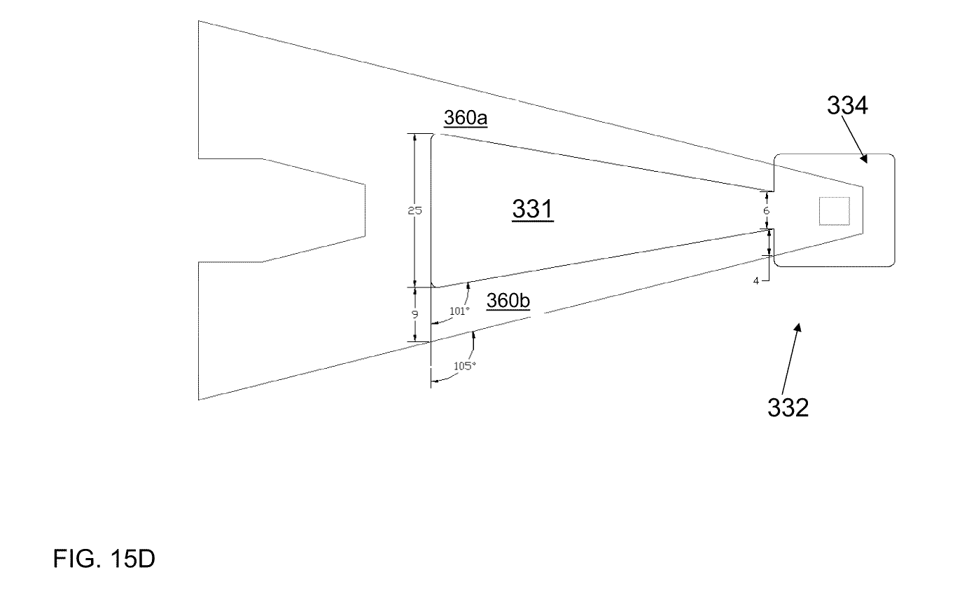

Top plan views of the masks for fabricating the cantilevers 220, 230, respectively, are shown in FIGS. 15A and 15B (see also FIGS. 15C and 15D, respectively). In FIG. 15A, it is shown that the square mask portion 324 for the base region is smaller than the end portion 322. The subsequently formed base region is thus surrounded by side walls. In FIG. 15B, it is shown that the square mask portion 334 is larger than the entire end portion 332. The resulting base region 234 thus essentially does not have a boundary. In FIG. 15B, the mask portion 334 for the base region 234 can be an expanded extension of the mask portion 331 for the channel 231. In addition, the masks of FIGS. 15B and 15D provide for substantial tapering in the sidewall (unlike in FIGS. 15A and 15C).

Silicon nitride cantilevers with integrated pyramidal tips can be fabricated by a method similar to that described by Albrecht et al. (Albrecht et al., Microfabrication of cantilever styli for the atomic force microscope. Journal of Vacuum Science & Technology A: Vacuum, Surfaces, and Films 1990; 8:3386-3396). Subsequent to crystallographic etching of the pyramidal pits and removal of the masking layer from the silicon wafer, an oxide layer is formed. This oxide is then patterned to form a region which includes the pyramidal pits and an adjoining triangular area. This oxide layer can serve the role of sharpening the tip, and/or otherwise controlling the apex radius and shape of the pit (Akamine, Low temperature thermal oxidation sharpening of microcast tips. J Vac Sci Technol B 1992; 10:2307-2310). While not limited by theory, compressive stress in the oxide layer can cause the oxide to expand in the direction normal to the surface. Near the bottom of the pyramidal pit this expansion can be frustrated by the proximity of the opposite face. This can result in a change of the cross sectional profile from v-shaped to cusped, and a reduction in the radius of curvature at the apex.

The oxide layer can also serve the role of forming a mold for a channel in the subsequently-formed silicon nitride cantilever. A step that is already performed to make sharp tips can thus be modified to make an open channel on the cantilever. Open channels for fluid transport are used for the inkwell products developed and sold by Nanolnk, Inc. (Skokie, Ill.).

In some alternative embodiments, the recessed base portion can have a side wall on one, two, or three sides. The side walls can be lower than the side wall regions of the channel.

7. Method of Printing

For rapid fabrication of millions of features over macro areas, DPN printing can use MEMS devices with high-density 1D and 2D pen arrays. These MEMS devices can significantly expand DPN capabilities in parallel printing of multiple materials but at the same time demand exceptional performance of each pen within the array.

One of the challenges that nanolithography is facing these days is nanoscale patterns with high-throughput, reproducibility and low cost.

Reproducible high-density chemical and biological patterns on solid substrates can be achieved using the systems disclosed herein. Such patterns can be useful for research and commercial applications related to nano and biotechnology, for example for spotting high-density protein and nucleic acid, DNA nano- and microarray, fabrication of lab-on-a-chip sensors, integrated circuits and MEMS.

A method of printing a microscopic or nanoscopic pattern on a surface is provided. The method includes depositing a fluid from a channel in a cantilever described above to the surface at an end portion of the cantilever. The end portion comprises a base region having a tip thereon, and wherein the base region has no boundary at least at one side or has a side wall substantially lower than a side wall of the channel. The depositing comprises drawing the fluid from the channel toward the base region through a surface tension difference between the fluid in the base region and the fluid in the channel. By moving the cantilever end portion relative to the surface, the fluid can be delivered from the cantilever end portion to the surface at different locations.

The resulting patterns can have features with a width of about 15 nm to about 100 microns, or about 100 nm to about 50 microns, or about one micron to about 25 microns, such as about one micron to about 15 microns. The cantilever end portion, particularly the tip, can be in contact with the surface during the depositing process. Features can be one micron or less in lateral dimension (e.g., diameter or line width).

The embodiments disclosed herein improve printing capabilities of the DPN for fabrication of the high-and biological chips or MEMS devices (for any liquid ink DPN printing, not limited to bio or MEMS). Using cantilevers with microfluidic channels can improve product quality and increases production volume.

Kits can be provided which comprise the devices described herein. The kits can also comprise at least one ink, at least one substrate, at least one inkwell, one or more other accessories, and/or at least one instruction sheet to use the kit.

Instruments can be also made to use the devices described herein. For example, printing instruments can be obtained from NanoInk, Inc. (Skokie, Ill.) including the DPN 5000 or NLP 2000 instruments. See, for example, US patent publication 2009/0023607 (NanoInk, Inc) describing a nanolithographic instrument.

What is claimed is:

1. A method for functionalizing sensors comprising:
providing a sensor element;
providing a pen array comprising at least a first tip and a second tip;
coating the first tip with a first ink composition and the second tip with a second ink composition;
functionalizing the sensor element by simultaneously depositing the first ink composition and second ink composition from the tips to the sensor element to form a first pattern and a second pattern each having a lateral dimension of 10 microns or less.

2. The method of claim 1, wherein the first and second patterns each have a lateral dimension of 1 micron or less.

3. The method of claim 1, wherein the first and second tips are atomic force microscope tips.

4. The method of claim 1, wherein the pen array is a one-dimensional pen array.

5. The method of claim 1, wherein the pen array is a two-dimensional pen array.

6. The method of claim 1, wherein the sensor element comprises a microcantilever.

7. The method of claim 1, wherein the sensor element comprises a nanocantilever.

8. The method of claim 1, wherein the sensor element comprises a vibrating stiff cantilever.

9. The method of claim 1, wherein the sensor element comprises a flexible cantilever.

10. The method of claim 1, wherein the sensor element comprises a microfluidic channel.

11. The method of claim 1, wherein the sensor element comprises a pillar array.

12. The method of claim 1, wherein the sensor element comprises a maze.

13. The method of claim 1, wherein the ink compositions comprise capture molecules.

14. The method of claim 1, wherein the ink compositions comprise proteins, peptides, or nucleic acids.

15. The method of claim 1, wherein the ink compositions comprise an aqueous carrier.

16. The method of claim 1, wherein the ink compositions comprises a surfactant or a matrix component.

17. The method of claim 1, wherein the deposition results in at least one line being formed.

18. The method of claim 1, wherein the deposition results in at least one dot being formed.

19. The method of claim 1, wherein the deposition results in a line width or a dot diameter of about one micron to about ten microns.

20. The method of claim 1, wherein the deposition results in a line width or a dot diameter of about one micron or less.

21. The method of claim 1, wherein the first pattern comprises a first capture molecule and the second pattern comprises a second capture molecule, and wherein the first capture molecule is different from the second capture molecule.

22. The method of claim 21, wherein the functionalized sensor element is substantially free of cross-contamination.

23. The method of claim 21, wherein the functionalized sensor element is substantially free of contamination in the background.

24. The method of claim 1, wherein the sensor element comprises an pre-fabricated surface structure comprising an arbitrary and non-flat surface, and wherein the deposition is adapted to the arbitrary and non-flat surface to be substantially free of both cross-contamination and contamination in the background.

25. The method of claim 1, wherein the pen array comprises at least 4 tips.

26. The method of claim 1, wherein the pen array comprise a plurality of cantilevers, wherein at least one of the cantilevers comprises a front surface, a first side edge, a second side edge, and a first end which is a free end, and a second end which is a non-free end, and wherein the front surface comprises (1) at least one first sidewall disposed at the first cantilever side edge and at least one second sidewall disposed at the second cantilever side edge opposing the first cantilever side edge, (2) at least one channel, adapted to hold a fluid, disposed between the first and second sidewalls, wherein the channel, the first sidewall, and the second sidewall extend toward the cantilever free end but do not reach the free end, and (3) a base region having a boundary defined by the first edge, the second edge, and the cantilever free end and also the first sidewall, second sidewall, and the channel, wherein the base region comprises a tip extending away from the cantilever front surface.

27. The method of claim 26, wherein the channel, the first side wall and the second side wall are all tapered to become gradually narrower as they extend toward the base region, and wherein the base region is substantially flush with the bottom surface of the channel.

28. The method of claim 26, wherein the pen array comprises at least one nanoscopic tip.

29. A method for functionalizing sensors comprising:
providing a sensor element;
providing at least one cantilever, wherein the cantilevers comprises a front surface, a first side edge, a second side edge, and a first end which is a free end, and a second end which is a non-free end, and wherein the front surface comprises (1) at least one first sidewall disposed at the first cantilever side edge and at least one second sidewall disposed at the second cantilever side edge opposing the first cantilever side edge, (2) at least one channel, adapted to hold a fluid, disposed between the first and second sidewalls, wherein the channel, the first sidewall, and the second sidewall extend toward the cantilever free end but do not reach the free end, and (3) a base region having a boundary defined by the first edge, the second edge, and the cantilever free end and also the first sidewall, second sidewall, and the channel, wherein the base region comprises a tip extending away from the cantilever front surface;
coating the tip with a ink composition comprising sensor molecules;
functionalizing the sensor element by depositing the sensor molecules from the tip to the sensor element to form a pattern having a lateral dimension of 10 microns or less, wherein the sensor molecules in the pattern are adapted to detect at least one analyte from a sample.

30. The method of claim 29, wherein the channel, the first side wall and the second side wall are all tapered to become gradually narrower as they extend toward the base region, and wherein the base region is substantially flush with the bottom surface of the channel.

31. A device comprising:
a chip;
wherein the chip comprises a plurality of sensor elements;
wherein each sensor element comprises a plurality of patterns disposed thereon, wherein at least one pattern has a lateral dimension of less than 10 microns,
wherein at least one sensor element comprises a first pattern comprising first sensing molecules and a second pattern comprising second sensing molecules, and
wherein the first sensor molecules are different from the second sensor molecules.

32. The device of claim 31, wherein the chip comprises at least 10 sensor elements.

33. The device of claim 31, wherein the chip comprises at least 50 sensor elements.

34. The device of claim 31, wherein at least one sensor element comprises at least 5 patterns.

35. The device of claim 31, wherein at least one sensor element comprises at least 50 patterns.

36. The device of claim 31, wherein at least one pattern has a lateral dimension of 1 micron or less.

37. The device of claim 31, wherein the first pattern and the second pattern are separated by a distance of 1 micron or less.

38. The device of claim 31, wherein the sensor elements comprise microcantilever.

39. The device of claim 31, wherein the sensor elements comprise nanocantilever.

40. The device of claim 31, wherein the sensor elements comprise vibrating stiff cantilever.

41. The device of claim 31, wherein the sensor elements comprise flexible cantilever.

42. The device of claim 31, wherein the sensor elements comprise microfluidic channel.

43. The device of claim 31, wherein the sensor elements comprise PDMS pillar array.

44. The device of claim 31, wherein the sensor elements comprise PDMS maze.

45. The device of claim 31, wherein at least one sensor element comprises a pre-fabricated surface structure, and wherein the pre-fabricated surface structure is arbitrary and non-flat.

46. The device of claim 31, wherein the sensing molecules comprise capture molecules.

47. The device of claim 31, wherein the sensing molecules comprise protein.

48. The device of claim 31, wherein the sensing molecules comprise nucleic acids.

49. The device of claim 31, wherein the sensing molecule comprises antibodies or an antigens.

50. The device of claim 31, wherein the sensing molecules are chemisorbed or covalently bonded to the sensor elements.

51. The device of claim 31, wherein at least part of at least one sensor element is passivated.

52. A device comprising:
a sensor chip;
wherein the chip comprises a plurality of sensor elements, including at least a first sensor element and a second sensor element;
wherein each sensor element comprises a plurality of patterns each having at a lateral dimension of less than 10 microns disposed thereon, wherein at least one pattern on each sensor element comprises a sensing molecule; and
wherein the first sensor element comprises at least one sensing molecule different from the second sensor element.

53. The device of claim 52, wherein at least one sensor comprises a first pattern comprising a first sensing molecule and a second pattern comprising a second sensing molecule, and wherein the first sensor molecule is different from the second sensor molecule.

54. A method for functionalizing sensors comprising
providing a chip, wherein the chip comprises a plurality of sensor elements;
providing a pen array comprising at least a first tip and a second tip;
coating the first tip with a first ink composition comprising at least one first sensing molecule and the second tip with a second ink composition comprising at least one second sensing molecule, wherein the first sensing molecule is different from the second sensing molecule;
functionalizing the chip by simultaneously depositing the first ink composition and second ink composition from the tips to at least one of the sensor elements to form a first pattern comprising the first sensing molecule and a second pattern comprising the second sensing molecule, wherein the first pattern and the second pattern each have a lateral dimension of 10 microns or less; and
wherein the functionalized chip is capable of sensing at least one analyte from a sample.

55. A method for functionalizing sensors comprising:
providing a chip, wherein the chip comprises a plurality of sensor elements including at least one first sensor element and one second sensor element;
providing a pen array comprising a plurality of tips each coated with an ink composition comprising at least one sensing molecule;
functionalizing the chip by depositing the ink compositions from the tips to the sensor elements to form a plurality of patterns on each sensor element;
wherein the patterns each has a lateral dimension of 10 microns or less;
wherein the functionalized chip are capable of sensing at least two different analyte from a sample; and
wherein the first sensor element is capable of sensing an analyte different from the second sensing element.
